(19) United States
(12) Patent Application Publication
(10) Pub. No.: US 2016/0195755 A1
(43) Pub. Date: Jul. 7, 2016

(54) OPTICAL MODULATION DEVICE AND DRIVING METHOD THEREOF

(71) Applicant: Samsung Display Co., Ltd., Yongin-City (KR)

(72) Inventor: Jong Suk Lee, Asan-si (KR)

(21) Appl. No.: 14/731,258

(22) Filed: Jun. 4, 2015

(30) Foreign Application Priority Data
Jan. 2, 2015 (KR) 10-2015-0000228

(51) Int. Cl. G02F 1/137

(52) U.S. Cl. CPC G02F 1/13731

(57) ABSTRACT

An optical modulation device and a method for driving the device are disclosed. In one aspect, the method includes applying a plurality of driving voltages having different voltage values to a plurality of lower electrodes and a selected one of the driving voltages to an upper electrode so as to generate substantially periodic phase modulation to a liquid crystal layer. The optical modulation device includes a first plate including the lower electrodes and a first aligner, a second plate facing the first plate and including an upper electrode and a second aligner, and the liquid crystal layer positioned between the first and second plates. The alignment directions of the first and second aligners are substantially parallel to each other. The method also includes applying a reset signal to the lower electrodes and the upper electrode so as to turn off the optical modulation device.

### INCORPORATION BY REFERENCE TO ANY PRIORITY APPLICATIONS

This application claims priority to and the benefit of Korean Patent Application No. 10-2015-0000228 filed in the Korean Intellectual Property Office on Jan. 2, 2015, the entire contents of which are incorporated herein by reference.

### BACKGROUND

1. Field

The described technology generally relates to an optical modulation device and a driving method thereof.

2. Description of the Related Technology

Electronic devices using optical modulation are being developed. For example, a three-dimensional (3D) display device has attracted attention, and an optical modulation device for dividing and transmitting an image at different viewpoints is required so that a viewer can recognize the image as a 3D image. In an optical modulation device that can be used in an autostereoscopic 3D image display, there are lenses, prisms, and the like which change the path of an image to a desired viewpoint.

As such, in order to change the direction of incident light, diffraction through phase modulation can be used.

When polarized light passes through the optical modulation device such as a phase retarder, a polarization state is changed. For example, when circularly polarized light is incident to a half-wavelength plate, a rotation direction of the circularly polarized light is reversely changed and thus the light is emitted. For example, when right circularly polarized light passes through the half-wavelength plate, left circularly polarized light is emitted. In this case, a phase of the emitted circularly polarized light varies according to an angle of an optical axis of the half-wavelength plate, that is, a slow axis. When the optical axis of the half-wavelength plate rotates by φ in-plane, the phase of the emitted light is changed by 2φ. Accordingly, when the optical axis of the half-wavelength plate rotates by 180° (π radian) in an x-axial direction in space, the emitted light has a phase modulation or a phase change of 360° (2π radian) in the x-axial direction. As such, when the optical modulation device causes the phase change of 0 to 2π according to position, a diffraction grid or a prism in which the direction of the passed light is changed or bent is implemented.

In order to easily control the optical axis according to optical modulation device position (such as the half-wavelength plate), a liquid crystal can be used. In the optical modulation device which is implemented as the phase retarder using the liquid crystal, long axes of liquid crystal molecules aligned by applying an electric field in a liquid crystal layer rotate to cause different phase modulation according to a position. The phase of the light emitted by passing through the optical modulation device can be determined according to a direction of long axes of the liquid crystal molecules, that is, an azimuthal angle.

The above information disclosed in this Background section is only for enhancement of understanding of the background of the described technology and therefore it can contain information that does not form the prior art that is already known in this country to a person of ordinary skill in the art.

### SUMMARY OF CERTAIN INVENTIVE ASPECTS

One inventive aspect relates to an optical modulation device including liquid crystal having advantages of modulating an optical phase by easily controlling an in-plane rotation angle of the liquid crystal molecules and forming various diffraction angles of light by controlling the rotation direction of the liquid crystal molecules.

Another aspect is a driving method of an optical modulation device including a first plate including a plurality of lower electrodes and a first aligner, a second plate facing the first plate and including an upper electrode and a second aligner, and a liquid crystal layer positioned between the first plate and the second plate according to an exemplary embodiment of the described technology, wherein an alignment direction of the first aligner and an alignment direction of the second aligner are substantially parallel to each other, includes: respectively applying a driving voltage to the lower electrode and the upper electrode to generate periodic phase modulation to the liquid crystal layer; and applying a reset signal to the lower electrode and the upper electrode to turn off the optical modulation device, wherein the application of the driving voltage to the plurality of lower electrodes and the upper electrode and the application of the reset signal to the plurality of lower electrodes and the upper electrode are alternated.

In the application of the reset signal to the plurality of lower electrodes and the upper electrode, a voltage difference between the voltage applied to the plurality of lower electrodes and the voltage applied to the upper electrode can be substantially 0.

The reset signal can be applied to the plurality of lower electrodes and the upper electrode when an interference degree in which an arrangement of liquid crystal molecules included in the liquid crystal layer is partially scattered is about 5% to about 10% after the driving voltage is applied to the plurality of lower electrodes and the upper electrode.

A period in which the reset signal is applied to the plurality of lower electrodes and the upper electrode can range from about 8 seconds to about 30 seconds.

A duration of applying the reset signal to the plurality of lower electrodes and the upper electrode can be one second or less.

In the application of the driving voltage to the plurality of lower electrodes and the upper electrode, in the liquid crystal layer corresponding to a first unit region including one lower electrode, an electric field intensity in a region near the first plate can be larger than an electric field intensity in a region near the second plate.

In the application of the driving voltage to the plurality of lower electrodes and the upper electrode, in the liquid crystal layer corresponding to a second unit region adjacent to the first unit region, the electric field intensity in a region near the first plate can be weaker than the electric field intensity in a region near the second plate.

In the application of the driving voltage to the plurality of lower electrodes and the upper electrode, a voltage applied to the lower electrode included in the first unit region can be larger than a voltage applied to the lower electrode included in the second unit region.

In the application of the driving voltage to the plurality of lower electrodes and the upper electrode, a first voltage is applied to the first lower electrode among the plurality of lower electrodes, a second voltage different from the first voltage can be applied to a second lower electrode adjacent to the first lower electrode, and a third voltage different from the first voltage and the second voltage can be applied to the upper electrode to form a first phase slope.

In the application of the driving voltage to the plurality of lower electrodes and the upper electrode, after the first voltage, the second voltage, and the third voltage are applied to the first and second lower electrodes and the upper electrode, respectively, a fourth voltage having an opposite polarity to the first voltage can be applied to the first lower electrode, and then a fifth voltage larger than the first voltage can be applied to the first lower electrode.

Another aspect is an optical modulation device that includes: a first plate including a plurality of lower electrodes and a first aligner; a second plate facing the first plate and including an upper electrode and a second aligner; and a liquid crystal layer positioned between the first plate and the second plate, wherein an alignment direction of the first aligner and an alignment direction of the second aligner are substantially parallel to each other, a step of applying a driving voltage to the plurality of lower electrodes and the upper electrode and a step of applying a reset signal to the plurality of lower electrodes and the upper electrode to turn off the optical modulation device are alternated.

Another aspect is a method for driving an optical modulation device, the method comprising: first applying a plurality of driving voltages having different voltage values to a plurality of lower electrodes and a selected one of the driving voltages to an upper electrode so as to generate substantially periodic phase modulation to a liquid crystal layer, wherein the optical modulation device includes a first plate including the lower electrodes and a first aligner, a second plate facing the first plate and including an upper electrode and a second aligner, and the liquid crystal layer positioned between the first and second plates, and wherein the alignment directions of the first and second aligners are substantially parallel to each other; and second applying a reset signal to the lower electrodes and the upper electrode so as to turn off the optical modulation device. The first applying and the second applying are alternately performed.

In the above method, in the second applying, the voltage difference between the lower electrodes and the upper electrode is substantially 0V.

In the above method, the second applying is performed when an interference degree, in which an arrangement of liquid crystal molecules included in the liquid crystal layer is partially scattered, is about 5% to about 10% after the first applying.

In the above method, the second applying is performed every about 8 seconds to about 30 seconds.

In the above method, the second applying is performed for about one second or less.

In the above method, during the first applying, in the liquid crystal layer corresponding to a first unit region including a first lower electrode of the lower electrodes, an electric field intensity in a region adjacent to the first plate is greater than an electric field intensity in a region adjacent to the second plate.

In the above method, during the first applying, in the liquid crystal layer corresponding to a second unit region including a second lower electrode of the lower electrodes and adjacent to the first unit region, the electric field intensity in a region adjacent to the first plate is less than the electric field intensity in a region adjacent to the second plate.

In the above method, during the first applying, a voltage applied to the first lower electrode is greater than a voltage applied to the second lower electrode.

In the above method, during the first applying, a first voltage is applied to the first lower electrode, a second voltage different from the first voltage is applied to the second lower electrode, and a third voltage different from the first and second voltages is applied to the upper electrode so as to form a first phase slope.

In the above method, first applying comprises: after the first to third voltages are respectively applied to the first and second lower electrodes and the upper electrode, applying a fourth voltage having an opposite polarity to the first voltage to the first lower electrode; and applying a fifth voltage greater than the first voltage to the first lower electrode after the applying of the fourth voltage.

In the above method, the second applying is performed when an interference degree, in which an arrangement of liquid crystal molecules included in the liquid crystal layer is partially scattered, is about 5% to about 10% after the applying of the driving voltage.

In the above method, the second applying is performed every about 8 seconds to about 30 seconds.

In the above method, the applying of the reset signal is performed for about one second or less.

Another aspect is an optical modulation device for a display device, comprising: a first plate including a plurality of lower electrodes and a first aligner; a second plate facing the first plate and including an upper electrode and a second aligner; a voltage application device configured to apply voltages to the lower and upper electrodes; and a liquid crystal layer positioned between the first and second plates, wherein the alignment directions of the first and second aligners are substantially parallel to each other, and wherein the voltage application device is configured to alternately apply i) a driving voltage to the lower and upper electrodes and ii) a reset signal to the lower and upper electrodes so as to turn off the optical modulation device.

In the above device, the voltage difference between a voltage of the lower electrodes and a voltage of the upper electrode is substantially 0V when the voltage application device is applying the reset signal.

In the above device, the voltage application device is further configured to apply the reset signal to the lower electrodes and the upper electrode when an interference degree, in which an arrangement of liquid crystal molecules included in the liquid crystal layer is partially scattered, is about 5% to about 10% after the driving voltage is applied to the lower and upper electrodes.

In the above device, the voltage application device is further configured to apply the reset signal every period that ranges from about 8 seconds to about 30 seconds.

In the above device, the voltage application device is further configured to apply the reset signal for about one second or less.

Another aspect is an optical modulation device for a display device, comprising: a first plate including a plurality of lower electrodes; a second plate facing the first plate and including an upper electrode; a liquid crystal layer positioned between the first and second plates and including a plurality of liquid crystal molecules each having an alignment direction corresponding to a default direction; and a voltage application device configured to i) apply driving voltages, for a duration of first and second periods, to the lower and upper electrodes so as to change the alignment direction of the liquid crystal molecules and ii) reset the alignment direction to the default direction between the first and second periods.

In the above device, the lower electrodes include a first lower electrode and a second lower electrode adjacent to the first lower electrode, wherein the voltage application device is further configured apply different driving voltages to the first and second lower electrodes and the upper electrode.

According to at least one of the disclosed embodiments, in the optical modulation device including the liquid crystal, the optical phase can be modulated by easily controlling an in-plane rotation angle of the liquid crystal molecules, and the various diffraction angles of light can be formed by controlling the rotation direction of the liquid crystal molecules. Also, the manufacturing process of the optical modulation device can be simplified. The optical modulation device including the liquid crystal can be easily enlarged and function as the lens to be used in an electronic device such as the stereoscopic image display device. The liquid crystal molecules of the optical modulation device can be prevented from being arranged in an abnormal direction by a foreign particle, and normal phase modulation can be prevented from being impossible by the propagation of the abnormal arrangement.

The described technology simplifies a manufacturing process of an optical modulation device including the liquid crystal. The optical modulation device including the liquid crystal can be easily enlarged and function as a lens to be used in an electronic device such as a 3D image display device. Also, the described technology provides an optical modulation device preventing the liquid crystal molecules of the optical modulation device from being arranged in an abnormal direction by a foreign particle, and thus, preventing the normal phase modulation from being blocked.

### BRIEF DESCRIPTION OF THE DRAWINGS

FIG. 1 is a perspective view of an optical modulation device according to an exemplary embodiment.

FIG. 2 is a top plan view showing an alignment direction in a first substrate and a second substrate included in an optical modulation device according to an exemplary embodiment.

FIG. 3 is a view showing a process of assembling the first plate and the second plate shown in FIG. 1.

FIG. 4 is a perspective view showing an arrangement of liquid crystal molecules when not applying a voltage difference to a first plate and a second plate of a optical modulation device according to an exemplary embodiment.

FIG. 5 is a cross-sectional view of the optical modulation device shown in FIG. 4 taken along planes I, II, and III.

FIG. 6 is a perspective view showing an arrangement of liquid crystal molecules when applying a voltage difference to a first plate and a second plate of an optical modulation device according to an exemplary embodiment.

FIG. 7 is a cross-sectional view of the optical modulation device shown in FIG. 6 taken along planes I, II, and III.

FIG. 8 is a perspective view of an optical modulation device according to an exemplary embodiment.

FIG. 9 is a timing diagram of a driving signal of an optical modulation device according to an exemplary embodiment.

FIG. 10 is a cross-sectional view showing an arrangement of liquid crystal molecules before applying a voltage difference after applying a driving signal of a first step to a first plate and a second plate of an optical modulation device according to an exemplary embodiment and taken along a plane IV of FIG. 8.

FIG. 11 is a cross-sectional view showing an arrangement of liquid crystal molecules of which an arrangement is stable after applying a driving signal to an optical modulation device according to an exemplary embodiment and taken along a plane V of FIG. 8, and a graph showing a phase change corresponding thereto.

FIG. 12 is a view showing an arrangement of liquid crystal molecules of which an arrangement is stable after applying a driving signal of a first step to an optical modulation device according to an exemplary embodiment.

FIG. 13 is a cross-sectional view showing an arrangement of liquid crystal molecules before applying a voltage difference to a first plate and a second plate of an optical modulation device according to an exemplary embodiment and taken along planes IV and V of FIG. 8.

FIG. 14 is a cross-sectional view of an arrangement of liquid crystal molecules directly after applying a driving signal of a first step to an optical modulation device according to an exemplary embodiment and taken along a plane IV of FIG. 8.

FIG. 15 is a cross-sectional view of an arrangement of liquid crystal molecules before being stable after applying a driving signal of a first step to an optical modulation device according to an exemplary embodiment and taken along a plane IV of FIG. 8.

FIG. 16 is a cross-sectional view showing an arrangement of liquid crystal molecules that is stable after applying a driving signal of a first step to an optical modulation device according to an exemplary embodiment and taken along planes IV and V of FIG. 8.

FIG. 17 is a cross-sectional view showing an arrangement of liquid crystal molecules before applying a voltage difference and after applying each driving signal of a first step to a third step to a first plate and a second plate of an optical modulation device according to an exemplary embodiment and taken along a plane IV of FIG. 8.

FIG. 18 and FIG. 19 are cross-sectional views showing an arrangement of liquid crystal molecules of which an arrangement is stable after sequentially applying driving signals of a first step to a third step to an optical modulation device according to an exemplary embodiment and taken along a line V of FIG. 8.

FIG. 20 and FIG. 21 are simulation graphs showing a phase change depending on a position of light passing through an optical modulation device according to an exemplary embodiment.

FIG. 22 is a view showing a phase change depending on a position of a lens realized by using an optical modulation device according to an exemplary embodiment.

FIG. 23 is a picture showing a shape in which an abnormal region in which an arrangement of liquid crystal molecules is scattered is propagated depending on time when an optical modulation device according to an exemplary embodiment is not periodically reset.

FIG. 24 is a picture showing a shape in which an abnormal region in which an arrangement of liquid crystal molecules is scattered is destroyed when an optical modulation device according to an exemplary embodiment is periodically reset.

FIG. 25 is a graph showing an interference level of the optical modulation device shown in FIG. 23 and FIG. 24.

FIG. 26 is a schematic cross-sectional view of an electronic device including an optical modulation device according to an exemplary embodiment.

FIG. 27 is an exploded perspective view of an electronic device according to an exemplary embodiment.

FIG. 28 is a timing diagram of a driving signal of an optical modulation device according to an exemplary embodiment.

FIG. 29 is a view showing a principle of a lens realized by using an optical modulation device according to an exemplary embodiment.

FIG. 30 and FIG. 31 are diagrams illustrating a schematic structure of a 3D image display device as one example of an optical device using the optical modulation device according to the exemplary embodiment and a method of displaying a 2D image and a 3D image, respectively.

### DETAILED DESCRIPTION OF CERTAIN INVENTIVE EMBODIMENTS

In order to implement a prism, a diffraction grid, a lens, or the like by causing continuous optical phase modulation of liquid crystals, their molecules need to be aligned so that long axes thereof are continuously changed according to position. In the case of a half-wavelength plate, an optical axis thereof needs to be changed from about 0 to about π so as to have a phase profile in which emitted light is changed from about 0 to about 2π according to position. To this end, an aligning process in different directions according to position with respect to a substrate adjacent to the liquid crystal layer is required, and thus made complicated. Further, when the aligning process needs to be minutely divided, it is difficult to uniformly perform the aligning process such as a rubbing process, and in the case where the aligning process is used in the display device, it results in display defects.

The described technology will be described more fully hereinafter with reference to the accompanying drawings, in which exemplary embodiments of the invention are shown. As those skilled in the art would realize, the described embodiments can be modified in various different ways, all without departing from the spirit or scope of the described technology.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements can also be present. In contrast, when an element is referred to as being “directly on” another element, there are no intervening elements present. In this disclosure, the term “substantially” includes the meanings of completely, almost completely or to any significant degree under some applications and in accordance with those skilled in the art. Moreover, “formed on” can also mean “formed over.” The term “connected” can include an electrical connection.

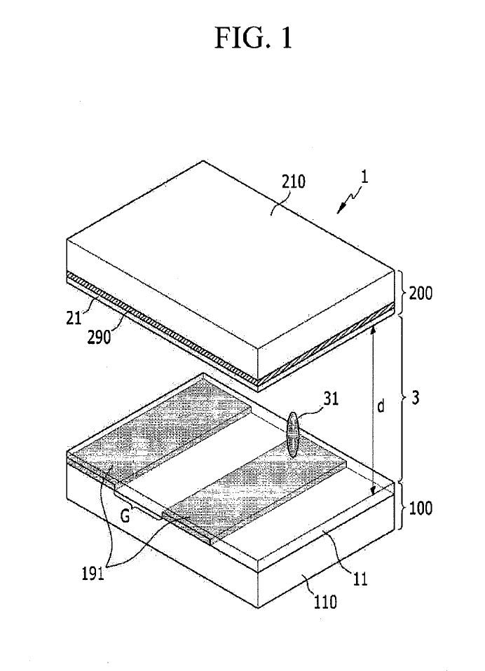

An optical modulation device according to an exemplary embodiment will be described with reference to FIG. 1 to FIG. 3.

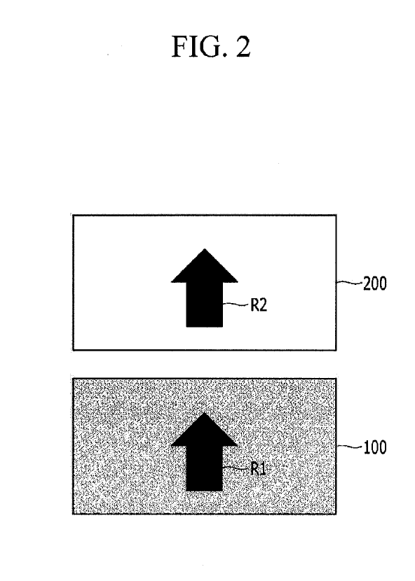

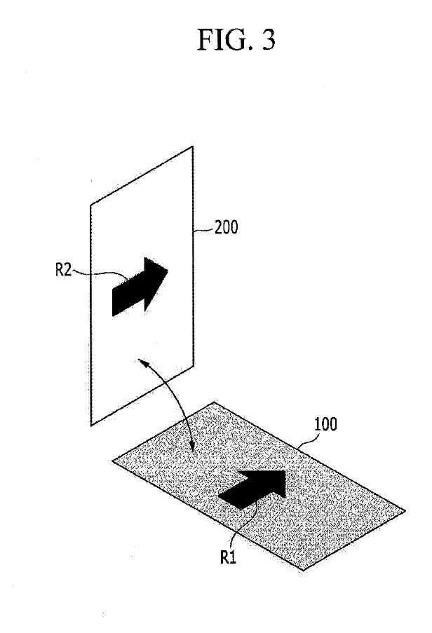

FIG. 1 is a perspective view of an optical modulation device according to an exemplary embodiment. FIG. 2 is a top plan view showing an alignment direction in a first substrate and a second substrate included in an optical modulation device according to an exemplary embodiment. FIG. 3 is a view showing a process of assembling the first plate and the second plate shown in FIG. 1.

Referring to FIG. 1, an optical modulation device 1 includes a first plate 100 and a second plate 200 which face each other, and a liquid crystal layer 3 positioned therebetween.

The first plate 100 includes a first substrate 110 formed of glass, plastic, or the like. The first substrate 110 can be rigid or flexible, and a surface thereof can be substantially flat or at least a part thereof can be bent.

A plurality of lower electrodes 191 are formed on the first substrate 110. Each lower electrode 191 is formed of a conductive material which can include a transparent conductive material such as ITO and IZO, or a metal. The lower electrodes 191 can be applied with a voltage from a voltage application unit or voltage application device (not shown), and lower electrodes 191 that are adjacent to each other or different from each other can be applied with different voltages.

The lower electrodes 191 can be arranged in a predetermined direction, for example, the x-axis direction, and each lower electrode 191 can be elongated in a direction substantially perpendicular to or crossing the arranged direction, that is, the y-axis direction.

The width of a space G between the adjacent lower electrodes 191 can be variously controlled depending on the design conditions of the optical modulation device. A ratio of the width of the lower electrode 191 and the width of the space G adjacent thereto can be about N:1 (N is a real number of 1 or more).

The second plate 200 can include a second substrate 210 that can be formed of glass, plastic, or the like. The second substrate 210 can be rigid or flexible, and can be substantially flat or bent at least in part.

An upper electrode 290 is positioned on the second substrate 210. The upper electrode 290 is formed of the conductive material which can include the transparent conductive material such as ITO and IZO or the metal. The upper electrode 290 can be applied with a voltage from the voltage application unit (not shown). The upper electrode 290 can be formed of a whole body on the second substrate 210, or can be patterned to include a plurality of separated portions.

Although not shown, a spacer to maintain an interval between the first plate 100 and the second plate 200 can be positioned between the first plate 100 and the second plate 200.

The liquid crystal layer 3 includes a plurality of liquid crystal molecules 31. The liquid crystal molecules 31 can have negative dielectric anisotropy such that they can be arranged in a transverse direction with respect to a direction of the electric field generated in the liquid crystal layer 3. The liquid crystal molecules 31 are aligned substantially vertically or crossing with respect to the second plate 200 and the first plate 100 in the absence of an electric field generated to the liquid crystal layer 3, and can be pre-tilted in a predetermined direction. The liquid crystal molecules 31 can be nematic liquid crystal molecules.

A height d of a cell gap of the liquid crystal layer 3 can substantially satisfy Equation 1 with respect to light having a predetermined wavelength. As a result, the optical modulation device 1 according to the exemplary embodiment can substantially function as a half-wavelength plate and be used as a diffraction grid, a lens, or the like.

$$\frac{λ}{2} \times 1.3 \geq Δ nd \geq \frac{λ}{2} \qquad Equation 1$$

In Equation 1, Δnd is a phase retardation value of light passing through the liquid crystal layer 3.

A first aligner 11 is positioned at an inner surface of the first plate 100 and a second aligner 21 is positioned at the inner surface of the second plate 200. The first aligner 11 and the second aligner 21 can be vertical alignment layers, and can have an alignment force produced by various methods such as a rubbing process and photoalignment, thereby determining a pretilt direction of the liquid crystal molecules 31 near the first plate 100 and the second plate 200. In the case of the rubbing process, the vertical alignment layer can be an organic vertical alignment layer. In the case of the photoalignment process, an alignment material including a photosensitive polymer material is coated on the inner surface of the first plate 100 and the second plate 200, and is irradiated with light such as ultraviolet rays to form a photopolymerization material.

Referring to FIG. 2, the alignment directions R1 and R2 of two aligners 11 and 21 positioned at the inner surface of the first plate 100 and the second plate 200 are substantially parallel to each other. Also, the alignment directions R1 and R2 of the aligners 11 and 21 are substantially constant.

When considering a misalignment margin of the first plate 100 and the second plate 200, a difference of the azimuth angle of the first aligner 11 of the first plate 100 and the azimuth angle of the second aligner 21 of the second plate 200 can be about 5 degrees, but is not limited thereto.

Referring to FIG. 3, the first plate 100 and the second plate 200 are aligned with each other and assembled to form the optical modulation device 1 according to an exemplary embodiment.

Alternatively, the vertical positions of the first plate 100 and the second plate 200 can be changed.

As described above, according to an exemplary embodiment, the aligners 11 and 21 formed in the first plate 100 and the second plate 200 of the optical modulation device 1 are parallel to each other and each alignment direction of the aligners 11 and 21 is constant such that the alignment process of the optical modulation device is simplified and the complicated alignment process is omitted, thereby simplifying the manufacturing process of the optical modulation device 1. Accordingly, a failure of the optical modulation device or the electronic device including the same due to the alignment failure can be prevented. Therefore, production of a large-sized optical modulation device is easy.

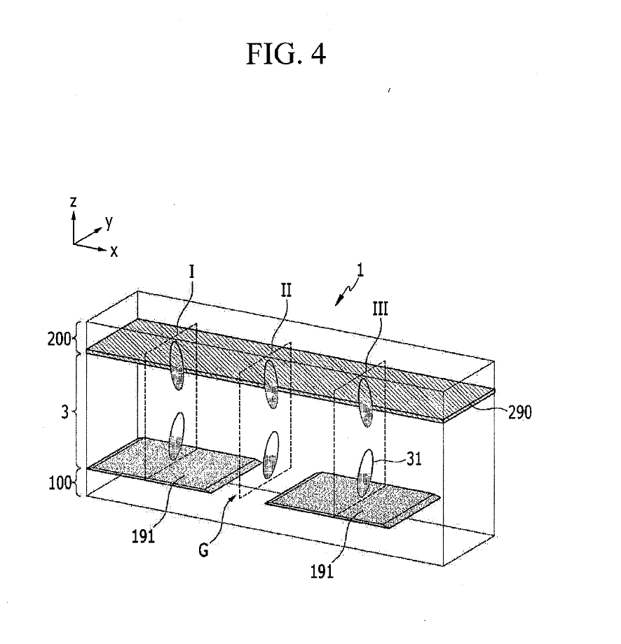

Next, an operation of the optical modulation device according to an exemplary embodiment will be described with reference to FIG. 4 to FIG. 7 along with FIG. 1 to FIG. 3.

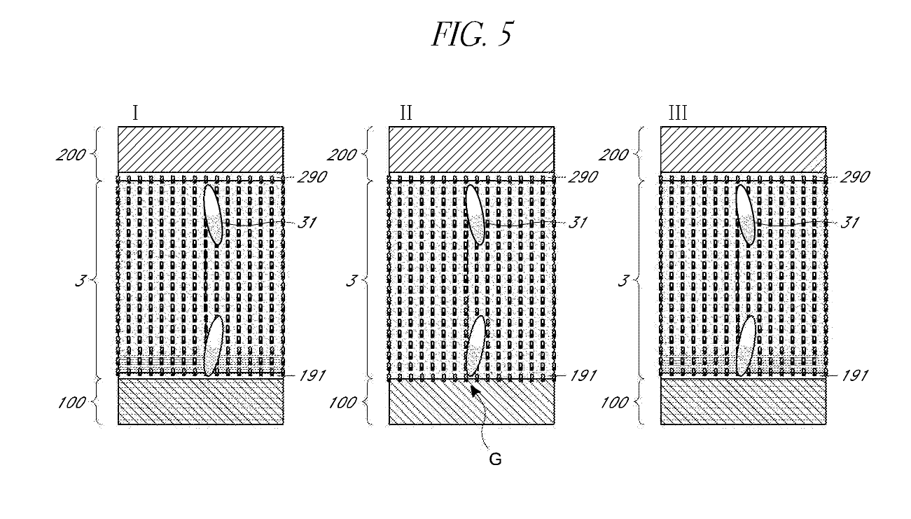

Referring to FIG. 4 and FIG. 5, when the voltage difference is not provided between the lower electrode 191 of the first plate 100 and the upper electrode 290 of the second plate 200 such that the electric field is not generated to the liquid crystal layer 3, the liquid crystal molecules 31 are arranged while having an initial pretilt angle. FIG. 5 is the cross-sectional view taken along the plane I corresponding to one lower electrode 191 among a plurality of lower electrodes 191 of the optical modulation device 1 shown in FIG. 4, the cross-sectional view taken along the plane II corresponding to the space G between two adjacent lower electrodes 191, and the cross-sectional view taken along the plane III corresponding to the lower electrode 191 adjacent to the other lower electrode 191. The arrangement of the liquid crystal molecules 31 can be substantially constant.

In the drawing of FIG. 5, some of the liquid crystal molecules 31 penetrate the region of the first plate 100 or the second plate 200, however this is for convenience of explanation, and in reality, the liquid crystal molecules 31 are positioned to not penetrate the region of the first plate 100 or the second plate 200, and the rest of the drawings are the same.

The liquid crystal molecules 31 near the first plate 100 and the second plate 200 are initially aligned along the alignment direction substantially parallel to the aligners 11 and 21 such that the pretilt direction of the liquid crystal molecule 31 near the first plate 100 and the pretilt direction of the liquid crystal molecule 31 near the second plate 200 are not parallel to each other and are substantially opposite. That is, the liquid crystal molecules 31 near the first plate 100 and the liquid crystal molecules 31 near the second plate 200 can be inclined to be substantially symmetrical to each other with reference to a transverse center line extending transversely along the center of the liquid crystal layer 3. For example, if the liquid crystal molecules 31 near the first plate 100 are inclined rightward, the liquid crystal molecules 31 near the second plate 200 are inclined leftward.

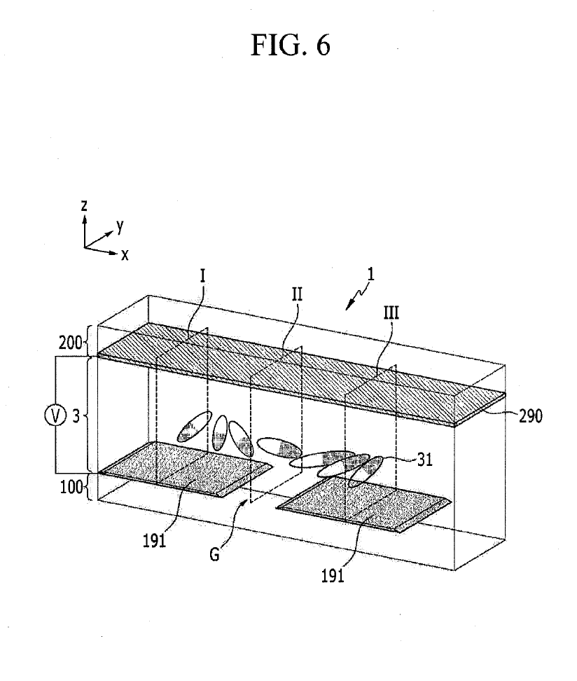

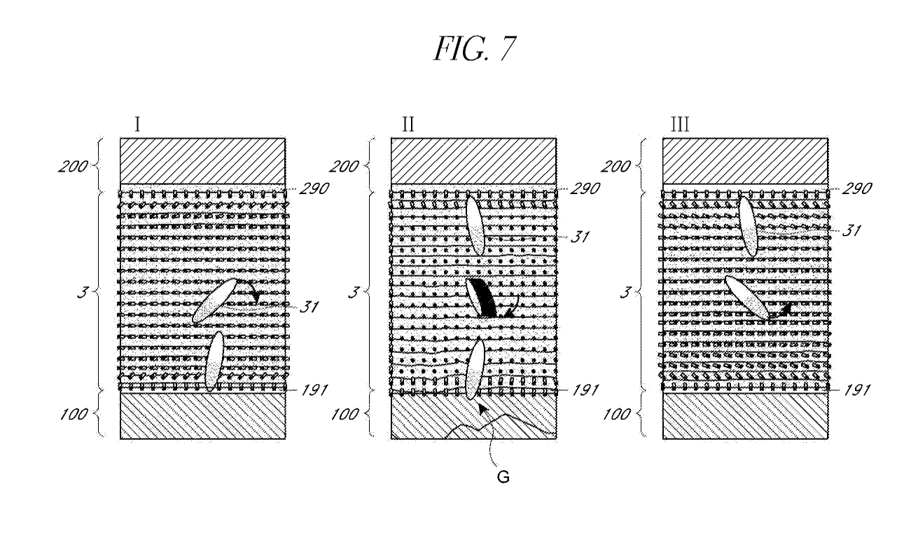

Referring to FIG. 6 and FIG. 7, a voltage difference of more than the threshold voltage is provided between the lower electrode 191 and the upper electrode 290 such that the liquid crystal molecules 31 having negative dielectric anisotropy tend to be inclined in the direction substantially perpendicular to or crossing the direction of the electric field directly after the electric field is generated to the liquid crystal layer 3. Accordingly, as shown in FIG. 6 and FIG. 7, the liquid crystal molecules 31 are mainly inclined to be substantially parallel to the surface of the first plate 100 or the second plate 200 to have an in-plane arrangement and the long axes of the liquid crystal molecules 31 are rotated in-plane and arranged. The in-plane arrangement means that the long axes of the liquid crystal molecules 31 are arranged to be substantially parallel to the surface of the first plate 100 or the second plate 200.

In this case, the rotation angle on the in-plane of the liquid crystal molecules 31, that is, the azimuthal angle, can be changed depending on the voltage applied to the lower electrode 191 and the upper electrode 290, and can be resultantly changed in a spiral depending on the position of the x-axis direction.

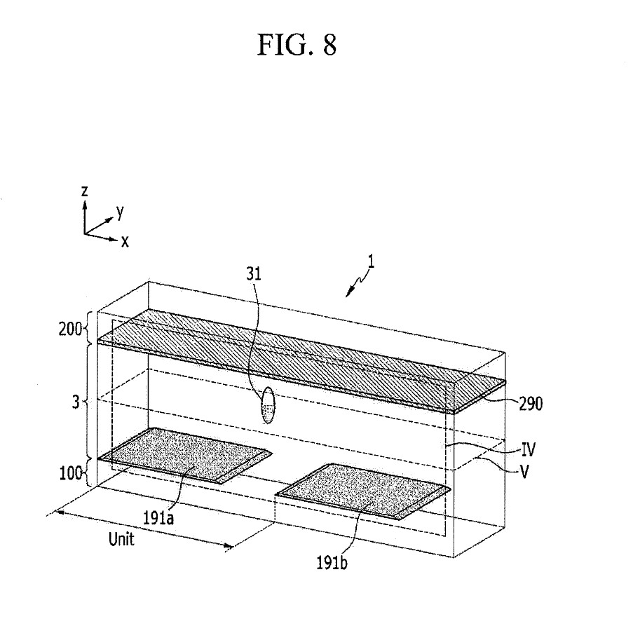

Next, a method of realizing a forward phase slope by using the optical modulation device 1 according to an exemplary embodiment will be described with reference to FIG. 8 to FIG. 12 along with the above-described drawings.

FIG. 8 shows the optical modulation device 1 including the liquid crystal according to an exemplary embodiment, and can have the same structure as the above-described exemplary embodiment(s). The optical modulation device 1 can include a plurality of unit regions, and each unit region (Unit) can include at least one lower electrode 191. In the present exemplary embodiment, each unit region (Unit) includes one lower electrode 191, and two lower electrodes 191a and 191b positioned in two adjacent unit regions will now be described. The two lower electrodes 191a and 191b are referred to as a first electrode 191a and a second electrode 191b.

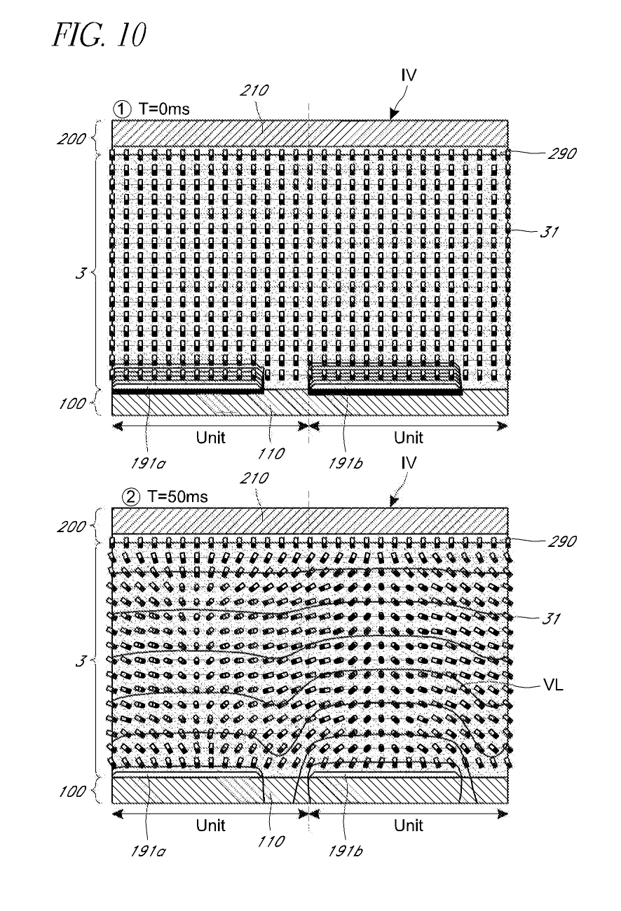

Referring to the upper view of FIG. 10, when the voltages are not applied to the first and second electrodes 191a and 191b and the upper electrode 290, the liquid crystal molecules 31 are initially aligned in the direction substantially vertical to or crossing the first plate 100 and the second plate 200, and can be pretilted with respect to the alignment direction of the first plate 100 and the second plate 200 as described above. In this case, the first and second electrodes 191a and 191b can be applied with a voltage of about 0 V with reference to the voltage of the upper electrode 290, and can be applied with a voltage of a threshold voltage Vth or less at which the alignment of the liquid crystal molecules 31 starts to be changed.

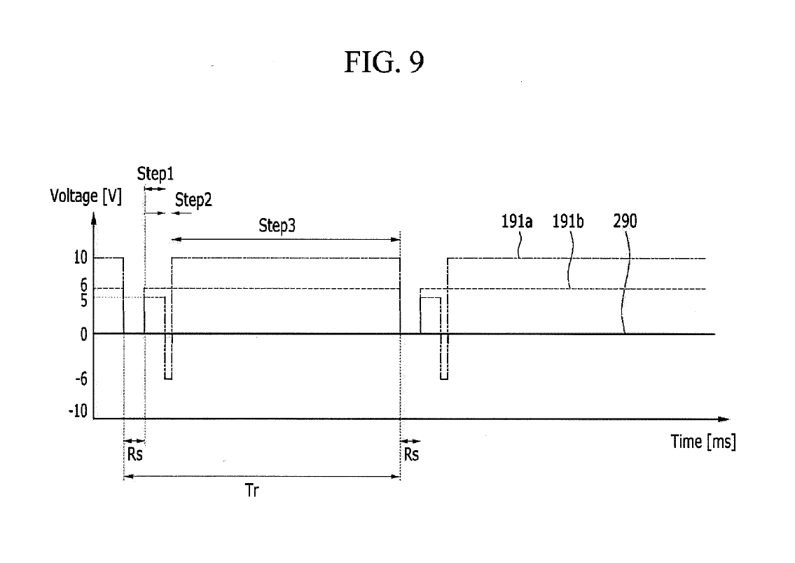

Referring to FIG. 9, the optical modulation device 1 according to an exemplary embodiment is repeatedly applied with the driving signal by a unit of one period Tr, and the one period Tr includes a plurality of driving sections. FIG. 9 shows an example in which one period Tr includes a reset section Rs and a plurality of step sections Step1, Step2, and Step3.

First, the step sections Step1, Step2, and Step3 will be described.

To realize the forward phase slope through the optical modulation device 1 according to an exemplary embodiment, the adjacent lower electrodes 191a and 191b and the upper electrode 290 can be applied with the driving signal of a first step (Step1) during one frame. In the first step (Step1), while the voltage difference is formed between the lower electrodes 191a and 191b and the upper electrode 290, the voltage difference is also formed between the adjacent first electrode 191a and second electrode 191b. For example, a magnitude of an absolute value of the second voltage applied to the second electrode 191b is greater than the magnitude of the absolute value of the first voltage applied to the first electrode 191a. Also, the third voltage applied to the upper electrode 290 is different from the first voltage and the second voltage applied to the lower electrodes 191a and 191b. For example, the third voltage applied to the upper electrode 290 is less than the absolute values of the first voltage and the second voltage applied to the first and second electrodes 191a and 191b. For example, the first electrode 191a is applied with about 5 V, the second electrode 191b is applied with about 6 V, and the upper electrode 290 is applied with 0 V.

Alternatively, when the unit area (Unit) includes the lower electrodes 191, the lower electrodes 191 of one unit area (Unit) can all be applied with substantially the same voltages, and the voltage that is sequentially changed by an unit of at least one lower electrode 191 can be applied. In this case, the lower electrode 191 of one unit area (Unit) with reference to the boundary of the adjacent unit areas (Unit) can be applied with the voltage that is gradually increased by the unit of at least one lower electrode 191, and the lower electrode 191 of the other unit area (Unit) can be applied with the voltage that is gradually decreased by the unit of at least one lower electrode 191.

The voltages applied to the lower electrodes 191 of all unit areas (Unit) can have the constant polarity as a positive polarity or a negative polarity with reference to the voltage of the upper electrode 290. Also, the polarity of the voltage applied to the lower electrode 191 can be reversed by the period of at least one frame.

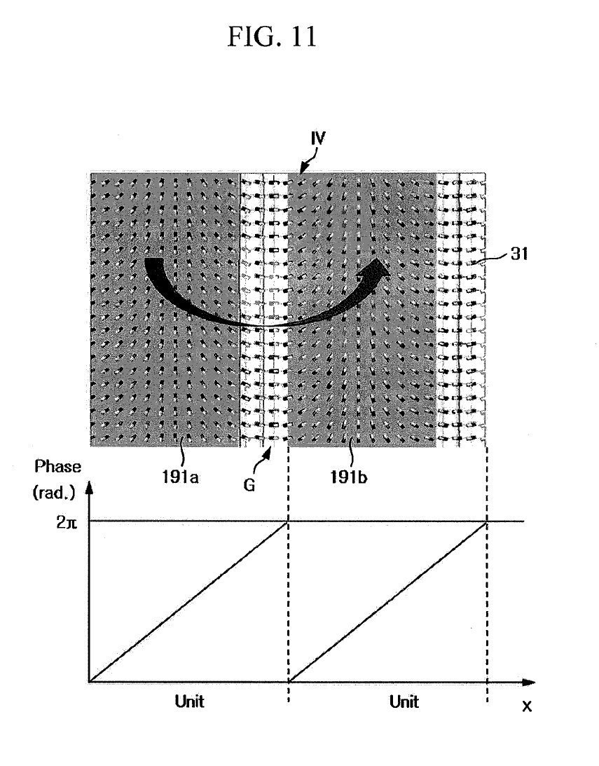

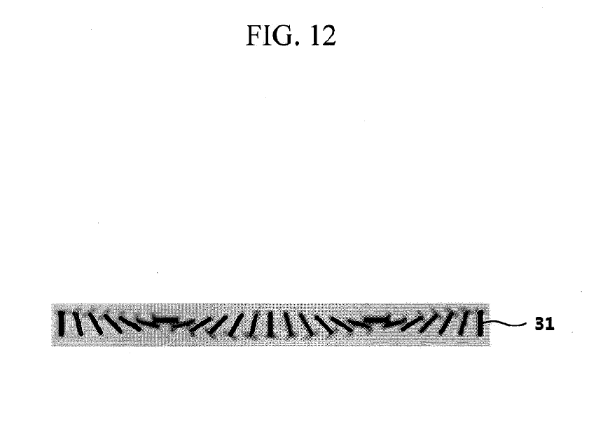

Thus, as shown in the lower view of FIG. 10 and FIG. 11, the liquid crystal molecules 31 are rearranged according to the electric field generated to the liquid crystal layer 3. In detail, the liquid crystal molecules 31 are mainly inclined to be substantially parallel to the surface of the first plate 100 or the second plate 200 thereby forming the in-plane arrangement, and the long axes thereof are rotated on the in-plane such that the spiral arrangement is formed as shown in FIG. 11 and FIG. 12, in detail, a substantially “u” shape is formed. In the liquid crystal molecules 31, azimuthal angles of the long axes of the liquid crystal molecules 31 can be changed from approximately 0° to approximately 180° on a period of a pitch of the lower electrode 191. A portion where the azimuthal angles of the long axes of the liquid crystal molecules 31 are changed from approximately 0° to approximately 180° can form one substantially “u” shape alignment.

A predetermined time can be required until the arrangement of the liquid crystal molecules 31 is stable after the optical modulation device 1 is applied with the driving signal of the first step (Step1), and the optical modulation device forming the forward phase inclination can be continually applied with the driving signal of the first step (Step1), differently from FIG. 9.

Referring to FIG. 11, the region where the liquid crystal molecules 31 are rotated along the x-axis direction by 180 degrees is defined as one unit region (Unit). In some embodiments, one unit region (Unit) includes the space G between the first electrode 191a and the second electrode 191b adjacent thereto.

As described above, when the optical modulation device 1 satisfies [Equation1] to be substantially realized as the half-wavelength plate, the rotation direction of the circularly-polarized light that is incident is reversely changed. FIG. 11 shows the phase change depending on the position of the x-axis direction when the right-circularly-polarized light is incident to the optical modulation device. The right-circularly-polarized light passing through the optical modulation device 1 is emitted to be changed into the left-circularly-polarized light, and the phase retardation value of the liquid crystal layer 3 is different depending on the x-axis direction such that the phase of the emitted circularly-polarized light is continuously changed.

If the light axis of the half-wavelength plate is generally rotated by φ degrees on the in-plane, the phase of the output light is changed by 2φ degrees, as shown in FIG. 11, and as a result, the phase of the light emitted from one unit region (Unit) in which the azimuthal angle of the long axes of the liquid crystal molecules 31 is changed to about 180° is changed from about 0 to about 2π (radian) in the x-axial direction. This is referred to as a forward phase slope. The phase change can be repeated every unit region (Unit), and the forward phase slope portion of the lens changing the direction of the light can be implemented by using the optical modulation device 1.

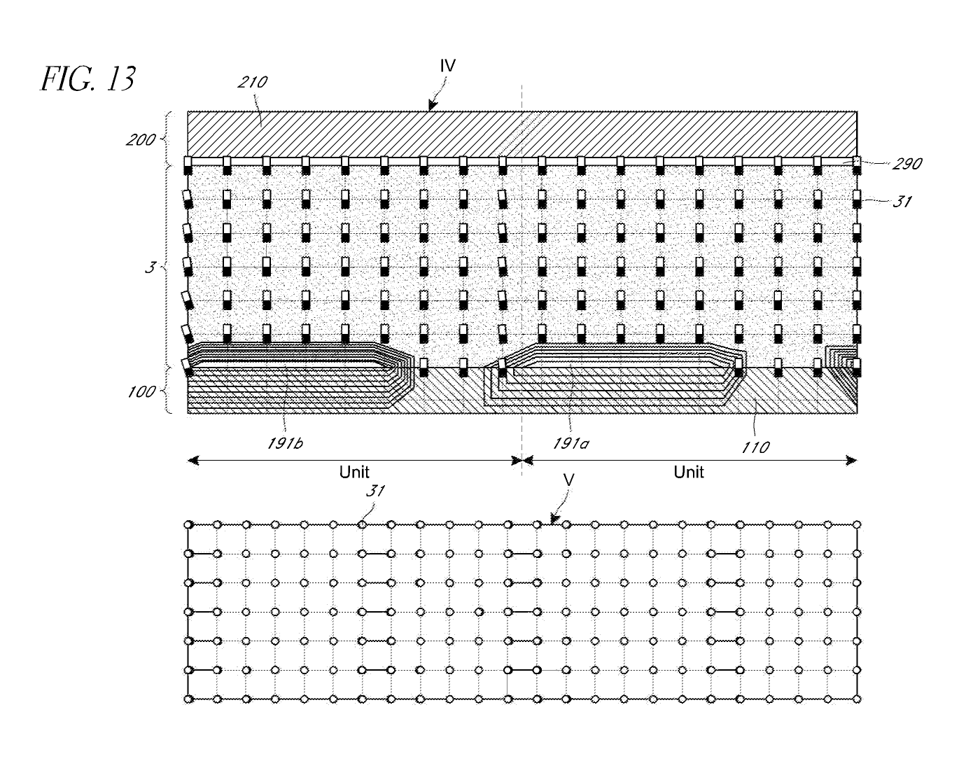

Next, a method of realizing the forward phase slope as shown in FIG. 11 through the optical modulation device according to an exemplary embodiment will be described with reference to FIG. 13 to FIG. 16 along with the above-described drawings.

FIG. 13 is a cross-sectional view showing an arrangement of liquid crystal molecules 31 before a voltage difference is applied to a first and second electrode 191a and 191b of a first plate 100 and an upper electrode 290 of a second plate 200 of an optical modulation device, taken along a plane IV of FIG. 9. FIG. 13 to FIG. 16 show the portion that is moved by one unit area (Unit) in the substantially horizontal direction differently from the above-described drawings.

The liquid crystal molecules 31 are initially aligned in the direction substantially perpendicular to the surface of the first plate 100 and the second plate 200, and can be pretilted along the alignment directions R1 and R2 of the first plate 100 and the second plate 200. Equipotential lines VL in the liquid crystal layer 3 are shown.

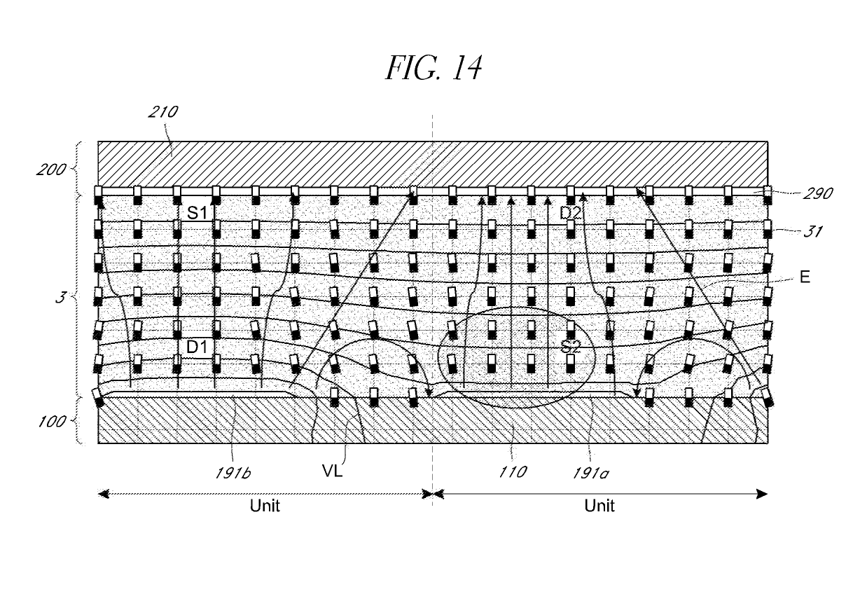

FIG. 14 is a cross-sectional view showing an arrangement of liquid crystal molecules 31 directly after a driving signal of a first step (Step1) is applied to the first and second electrodes 191a and 191b of the first plate 100 and the upper electrode 290 of the second plate 200 of an optical modulation device according to an exemplary embodiment, taken along plane IV of FIG. 9, as the portion that is substantially horizontally moved by one unit area (Unit). The electric field E is generated to the liquid crystal layer 3, and the equipotential lines VL according thereto are shown. In this case, since the first and second electrodes 191a and 191b have an edge side, as shown in FIG. 14, a fringe field can be formed between the edge side of the first and second electrodes 191a and 191b and the upper electrode 290.

In the liquid crystal layer 3 of the unit region (Unit) including the second electrode 191b directly after the driving signal of the first step (Step1) is applied to the first and second electrodes 191a and 191b and the upper electrode 290, the intensity of the electric field in the region D1 near the first plate 100 is greater than the intensity of the electric field in the region S1 near the second plate 200. In the liquid crystal layer 3 of the unit region (Unit) including the first electrode 191a, the intensity of the electric field in the region S2 near the first plate 100 is less than the electric field in the region D2 near the second plate 200.

The voltages applied to the first electrode 191a and the second electrode 191b of two adjacent unit regions has the difference (Unit) as shown in FIG. 14, and the intensity of the electric field in the region S2 near the first electrode 191a can be less than the intensity of the electric field in the region D1 near the second electrode 191b. For this, as shown in FIG. 9, the voltage applied to the second electrode 191b can be greater than the voltage applied to the first electrode 191a. The upper electrode 290 can be applied with the voltage that is different from the voltage applied to the first and second electrodes 191a and 191b, and the voltage that is less than the voltage is applied to the first and second electrodes 191a and 191b.

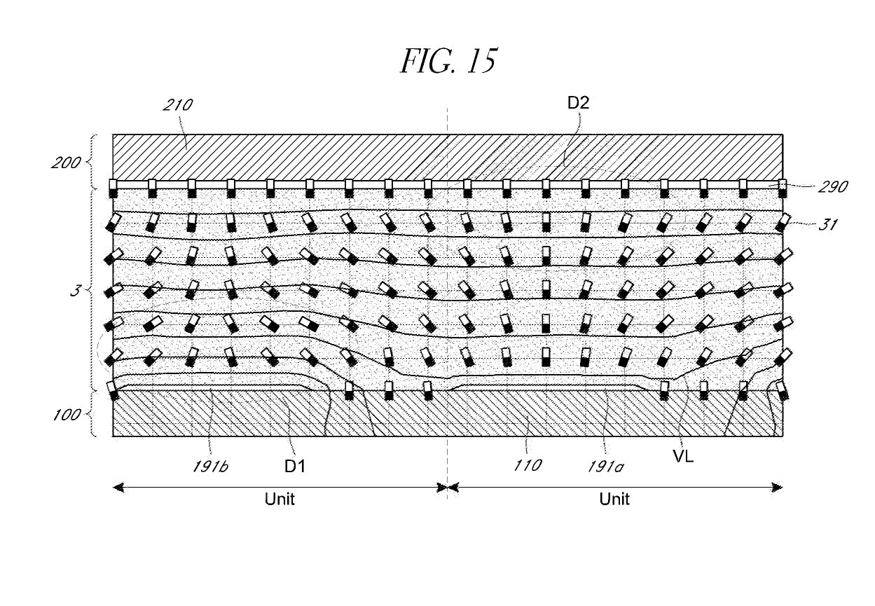

FIG. 15 is a cross-sectional view showing an arrangement of liquid crystal molecules 31 having reacted to the electric field E generated to the liquid crystal layer 3 after the driving signal of the first step (Step1) is applied to the optical modulation device shown in FIG. 8, taken along a plane IV shown in FIG. 8, as the portion that is horizontally moved by one unit area (Unit). As described above, in the liquid crystal layer 3 corresponding to the second electrode 191b, the electric field in the region D1 near the second electrode 191b is greatest such that the inclined direction of the liquid crystal molecules 31 of the region D1 resultantly determines the in-plane arrangement direction of the liquid crystal molecules 31 corresponding to the second electrode 191b. Accordingly, in the region corresponding to the second electrode 191b, the liquid crystal molecules 31 are inclined in the initial pretilt direction of the liquid crystal molecules 31 near the first plate 100, thereby forming the in-plane arrangement.

In contrast, in the liquid crystal layer 3 corresponding to the first electrode 191a, the electric field in the region D2 near the upper electrode 290 is greatest such that the inclined direction of the liquid crystal molecules 31 of the region D2 resultantly determines the in-plane arrangement direction of the liquid crystal molecules 31. Accordingly, in the region corresponding to the first electrode 191a, the liquid crystal molecules 31 are increased in the initial pretilt direction near the second plate 200, thereby forming the in-plane arrangement. The initial pretilt direction of the liquid crystal molecules 31 near the first plate 100 and the initial pretilt direction of the liquid crystal molecules 31 near the second plate 200 are opposite to each other such that the inclined direction of the liquid crystal molecules 31 corresponding to the first electrode 191a is opposite to the inclined direction of the liquid crystal molecules 31 corresponding to the second electrode 191b.

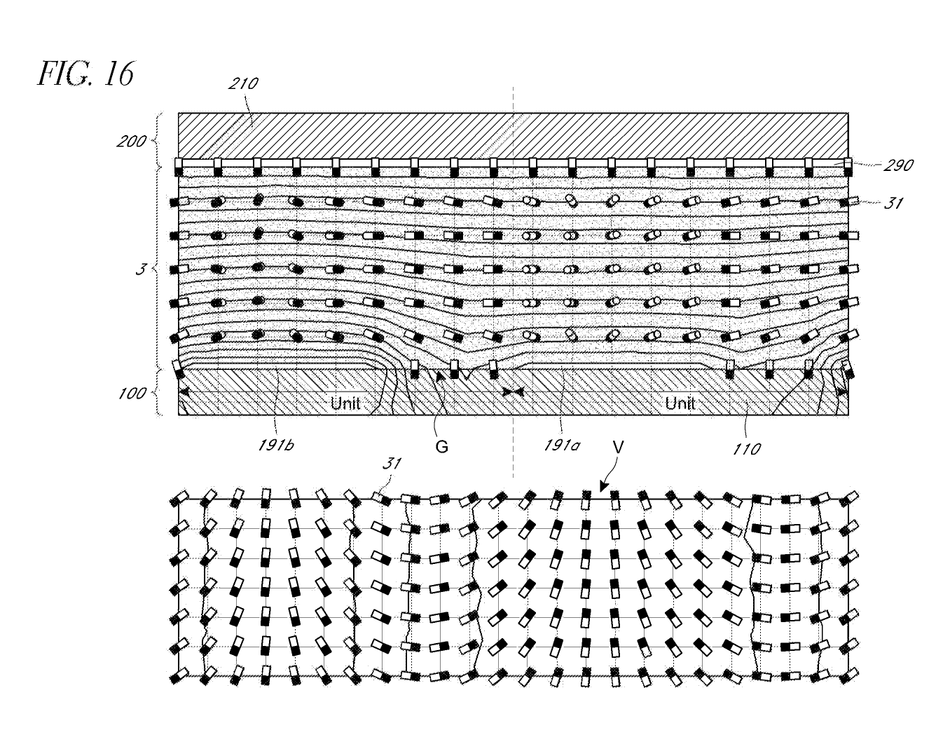

FIG. 16 is a cross-sectional view showing an arrangement of liquid crystal molecules that is stable after a driving signal of a first step (Step1) is applied to an optical modulation device 1 shown in FIG. 8, taken along planes IV and V shown in FIG. 8, as the portion that is substantially horizontally moved by one unit area (Unit). The in-plane arrangement direction of the liquid crystal molecules 31 corresponding to the first electrode 191a is substantially opposite to the in-plane arrangement direction of the liquid crystal molecules 31 corresponding to the second electrode 191b, and the liquid crystal molecules 31 corresponding to the space G between the adjacent first electrode 191a and second electrode 191b are continuously rotated along the x-axis direction, thereby forming the spiral arrangement.

Finally, the liquid crystal layer 3 of the optical modulation device 1 can provide the phase retardation that is changed along the x-axis direction for the incident light.

Referring to FIG. 16, the region where the liquid crystal molecules 31 are rotated along the x-axis direction by 180 degrees is defined as one unit region (Unit), and one unit region (Unit) includes the space G between one lower electrode 191a or 191b and the different lower electrode 191a or 191b adjacent thereto. For example, when the right-circularly-polarized light is incident to the optical modulation device 1 forming the forward phase slope, the phase change depending on the position of the x-axis direction appears, the right-circularly-polarized light is changed into the left-circularly-polarized to be emitted and the phase retardation value of the liquid crystal layer 3 is different depending on the x-axis direction such that the phase of the emitted circularly-polarized light is also continuously changed.

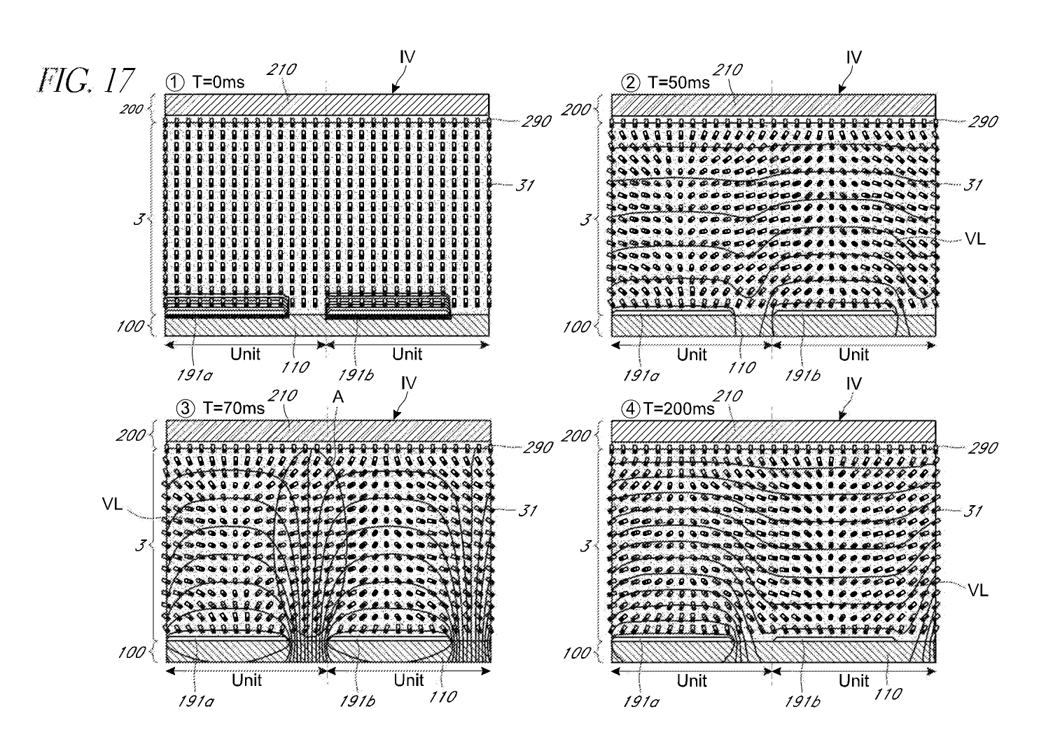

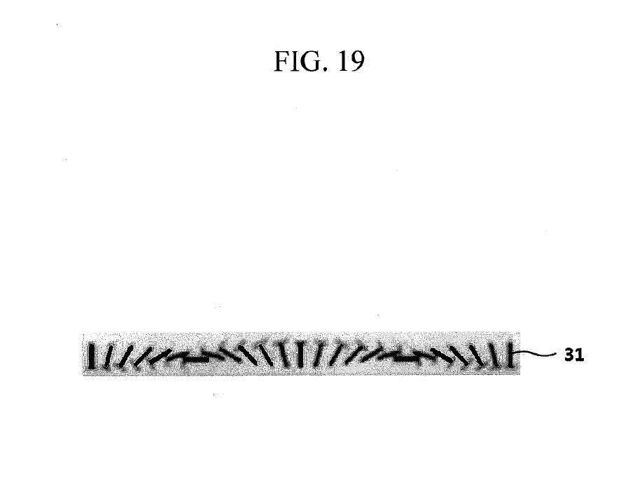

Next, a method realizing a backward phase slope by using the optical modulation device according to an exemplary embodiment will be described with reference to FIG. 17 to FIG. 19 along with the above-described drawings, particularly FIG. 9 to FIG. 11.

Referring to the left-upper view of FIG. 17, when the voltages are not applied to the first and second electrodes 191a and 191b and the upper electrode 290, the liquid crystal molecules 31 are initially aligned in the direction substantially vertical to or crossing the surfaces of the first plate 100 and the second plate 200, and can pretilted along the alignment direction of the first plate 100 and the second plate 200, as described above.

Referring to FIG. 9 in the optical modulation device 1 according to an exemplary embodiment, the lower electrodes 191a and 191b and the upper electrode 290 are applied with the driving signal of a second step (Step2) after a predetermined time after the driving signal of the first step (Step1) is applied.

In the second step (Step2), the adjacent first electrode 191a and second electrode 191b can be applied with the voltages of the opposite polarities with reference to the voltage applied to the upper electrode 290. For example, the first electrode 191a is applied with the voltage of about −6 V and the second electrode 191b applied with the voltage of about 6 V with reference to the voltage of the upper electrode 290, but can be different.

Thus, the equipotential lines VL as shown in the left-lower view of FIG. 17 are formed and the liquid crystal molecules 31 of the area A corresponding to the space between the first and second electrodes 191a and 191b are arranged in the direction substantially vertical to or crossing the substrates 100 and 200 and the in-plane spiral arrangement is broken.

Alternatively, when the unit area (Unit) includes the lower electrodes 191, the lower electrodes 191 of one unit area (Unit) can all be applied with substantially the same voltage and the voltage that is sequentially changed by a unit of at least one lower electrode 191 can be applied. The voltages applied to the lower electrodes 191 of the adjacent unit areas (Unit) can be the voltage of the opposite polarity with reference to the voltage of the upper electrode 290. Also, the polarity of the voltage applied to the lower electrode 191 can be reversed by a period of at least one frame.

Next, in the optical modulation device 1 according to an exemplary embodiment, the lower electrodes 191a and 191b and upper electrode 290 are applied with the driving signal of the third step (Step3) after the predetermined time after the driving signal of the second step (Step2) is applied.

In the third step (Step3), the voltage level applied to the lower electrodes 191a and 191b and the upper electrode 290 is similar to that of the first step (Step1), however the relative magnitude of the voltages applied to the first electrode 191a and the second electrode 191b can be reversely exchanged. That is, in the first step (Step1), if the voltage applied to the first electrode 191a is less than the voltage applied to the second electrode 191b, in the third step (Step3), the voltage applied to the first electrode 191a can be greater than the voltage applied to the second electrode 191b. For example, in the third step (Step3), the first electrode 191a is applied with about 10 V, the second electrode 191b is applied with about 6 V, and the upper electrode 290 is applied with about 0 V.

Thus, as shown in the right-lower view of FIG. 17, the liquid crystal molecules 31 are rearranged depending on the electric field generated to the liquid crystal layer 3. For example, the liquid crystal molecules 31 are mainly inclined to be substantially parallel to the surface of the first plate 100 or the second plate 200 thereby forming the in-plane arrangement. The long axes thereof are rotated on the in-plane such that the spiral arrangement is formed as shown in FIG. 12, for example, a substantially “n” shape is formed. In the liquid crystal molecules 31, azimuthal angles of the long axes of the liquid crystal molecules 31 can be changed from approximately 180° to approximately 0° on a period of a pitch of the lower electrode 191. A portion where the azimuthal angles of the long axes of the liquid crystal molecules 31 are changed from approximately 180° to approximately 0° can form one substantially “n” shape alignment.

A predetermined time can be required until the arrangement of the liquid crystal molecules 31 is stable after the optical modulation device 1 is applied with the driving signal of the third step (Step3), and the optical modulation device 1 forming the backward phase inclination can be continually applied with the driving signal of the third step (Step3).

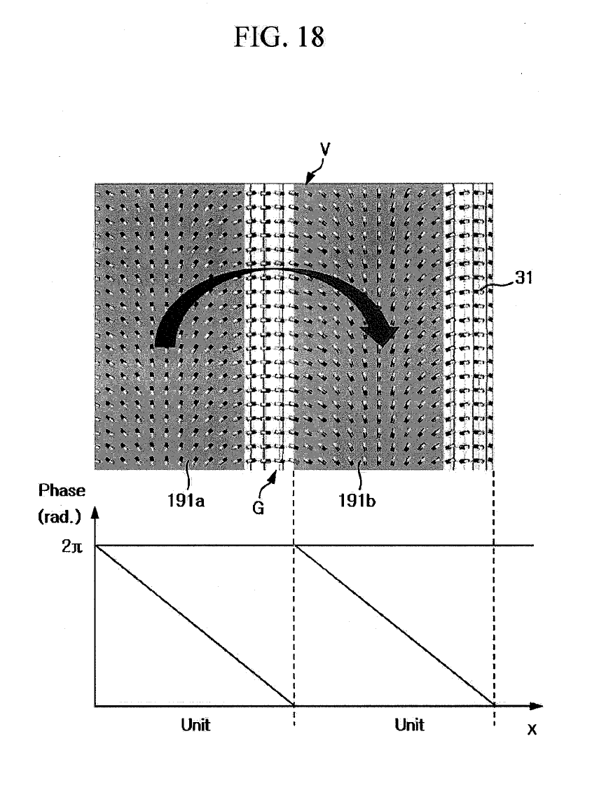

As described above, when the optical modulation device satisfies [Equation1] to be substantially realized as the half-wavelength plate, the rotation direction of the circularly-polarized light that is incident is reversely changed. FIG. 18 showing the phase change depending on the position of the x-axis direction when the right-circularly-polarized light is incident to the active area of the optical modulation device 1. The right-circularly-polarized light passing through the active area of the optical modulation device is emitted to be changed into the left-circularly-polarized light and the phase retardation value of the liquid crystal layer 3 is different depending on the x-axis direction such that the phase of the emitted circularly-polarized light is continuously changed.

If the light axis of the half-wavelength plate is generally rotated by φ degrees on the in-plane, the phase of the output light is changed by 2φ degrees, as shown in FIG. 12, and as a result, the phase of the light emitted from one unit region (Unit) in which the azimuthal angle of the long axes of the liquid crystal molecules 31 is changed to about 180° is changed from about 2π (radian) to about 0 in the x-axial direction. This is referred to as a backward phase slope. The phase change can be repeated every unit region (Unit), and the backward phase slope portion of the lens changing the direction of the light can be implemented by using the optical modulation device.

As such, according to at least one of the disclosed embodiments, the in-plane rotation angle of the liquid crystal molecules 31 is easily controlled according to a method of applying the driving signal to variously modulate an optical phase and form various diffraction angles of light.

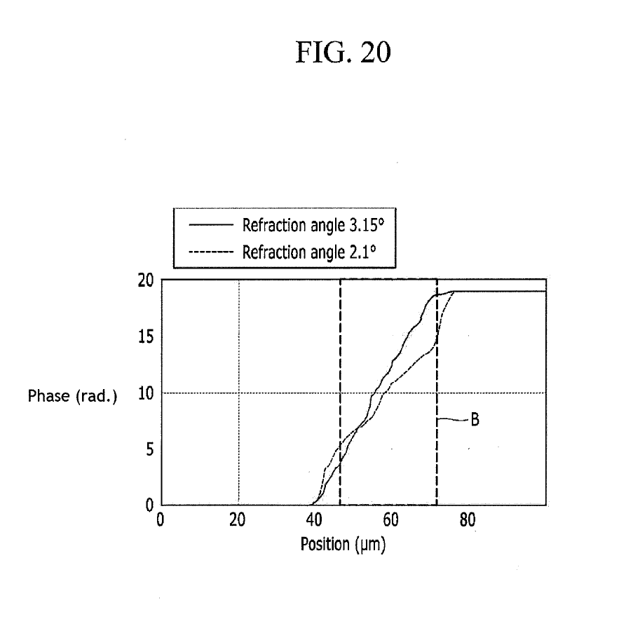

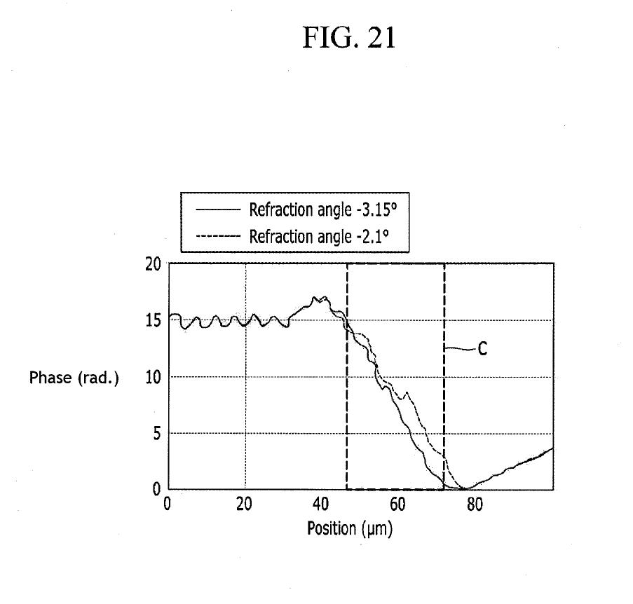

FIG. 20 and FIG. 21 are simulation graphs showing a phase change depending on a position of light passing through an optical modulation device according to an exemplary embodiment.

Referring to FIG. 20, if the above-described driving signal of the first step (Step1) is applied to the optical modulation device 1, the forward phase slope depending on the position is realized like a portion B. Referring to FIG. 21, the backward phase slope is realized depending on the position like the portion C if the above-described driving signal of the first step (Step1) to the third step (Step3) is sequentially applied to the optical modulation device 1.

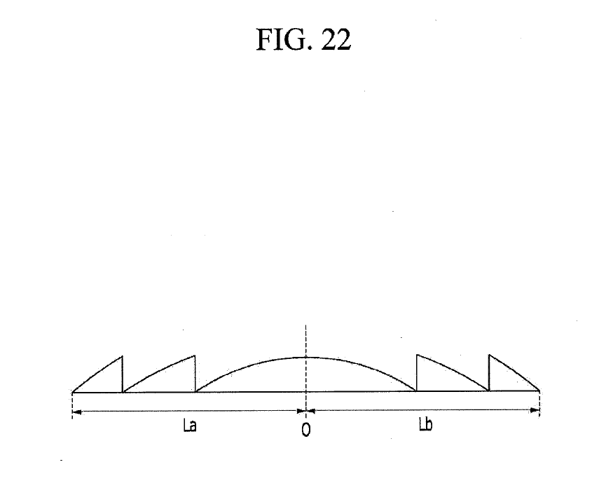

FIG. 22 is a view showing a phase change depending on a position of a lens realized by using an optical modulation device according to an exemplary embodiment.

The optical modulation device 1 can realize the forward phase slope and the backward phase slope by differentiating the application method of the driving signal depending on the position as described above, thereby forming the lens. FIG. 22 shows the phase change depending on the position of a Fresnel lens as an example of the lens realized by the optical modulation device 1. The Fresnel lens is a lens using an optical characteristic of a Fresnel zone plate, and can have an effective phase delay which is identical or similar to that of a solid convex lens or a GRIN lens since the refractive index distribution is substantially periodically repeated.

As illustrated in FIG. 22, based on the center O of one Fresnel lens, a left portion La includes a plurality of forward phase slope areas having different widths in the x-axis direction, and a right portion Lb includes a plurality of backward phase slope areas having different widths in the x-axis direction. Accordingly, only the portion of the optical modulation device 1 corresponding to the left portion of the lens can be applied with the driving signal of the first step (Step1) as described above, thereby forming the forward phase slope. The portion of the optical modulation device 1 corresponding to the right portion Lb of the lens can be sequentially applied with the driving signal of the first step (Step1), the second step (Step2), and the third step (Step3), thereby forming the backward phase slope.

The forward phase slopes included in the left portion La of the Fresnel lens can have different widths depending on the position, and for this, the width of the lower electrode 191 of the optical modulation device corresponding to each forward phase slope portion and/or the number of the lower electrodes 191 included in one unit area (Unit) can be appropriately controlled. Likewise, the forward phase slopes included in the right portion Lb of the Fresnel lens can have different widths depending on the position, and for this, the width of the lower electrode 191 of the optical modulation device corresponding to each forward phase slope portion and/or the number of the lower electrodes 191 included in one unit area (Unit) can be appropriately controlled.

By controlling the voltages applied to the lower electrode 191 and the upper electrode 290, the phase curvature of the Fresnel lens can also be changed.

Referring to FIG. 9 again, after the predetermined time after realizing the forward phase slope by applying the driving signal of the first step (Step1) and realizing the backward phase slope by applying the driving signal of the first step to the third step (sStep1, Step 2, and Step 3), a reset signal is applied to the lower electrodes 191a and 191b and the upper electrode 290 during a reset section Rs to reset the optical modulation device 1. The reset signal applied in the reset section Rs can be a signal so as to not apply the voltage difference to all electrodes, that is, between the lower electrodes 191a and 191b and the upper electrode 290. In detail, the lower electrodes 191a and 191b and the upper electrode 290 can all be applied with substantially the same voltage, for example, about 0 V. Thus, the liquid crystal molecules 31 of the liquid crystal layer 3 are returned in the initial state and the optical modulation device 1 is turned off such that the phase modulation is not generated.

The reset section Rs can be maintained during a predetermined time and the predetermined time can be about 1 second such that the liquid crystal molecules 31 sufficiently respond corresponding to the start of the reset section Rs. However, the predetermined time of the reset section Rs is not limited thereto and can be changed by considering several conditions such as a response speed of the liquid crystal molecules 31. For example, the predetermined time of the reset section Rs is determined by considering the displayed stereoscopic image or an interference degree of the multi-view image when using the optical modulation device 1 as the lens in the stereoscopic image display device.

The section generating the periodic phase modulation by applying the driving signal to the lower electrodes 191a and 191b and the upper electrode 290 and the step of resetting them by applying the reset signal can be alternated.

The repetition period of the reset section Rs, that is, one period Tr shown in FIG. 9, can be determined by considering the time that the interference starts to be recognized in the image observed through the optical modulation device 1 when the normal arrangement of the liquid crystal molecules 31 is broken such that the phase modulation disappears after starting to realize the forward phase slope by applying the driving signal of the first step (Step 1) to the optical modulation device 1 or the backward phase slope by applying the driving of the first step (Step1) to the third step (Step 3), and/or the interference degree. The interference degree can be substantially proportional to a degree that the phase modulation is scattered. For example, the repetition period of the reset section Rs, that is, one period Tr shown in FIG. 9, is determined so that the voltage of the reset section Rs is applied to the optical modulation device 1 when the interference degree of the image displayed by the display device including the optical modulation device 1 can be changed by about 6% to about 10%. However, depending on embodiments, the interference degree change can be less than about 6% or greater than about 10%. The repetition period of the reset section Rs can be within about 60 seconds, for example, in a range from about 8 seconds to about 30 seconds, however it is not limited thereto. However, depending on embodiments, the repetition period can be greater than about 60 seconds.

For example, when the optical modulation device 1 is included in the display device, if the reset section Rs is synchronized with a time (a shot conversion time) that the displayed image is converted, the turn-off of the optical modulation device 1 at the reset section Rs can be prevented from being recognized.

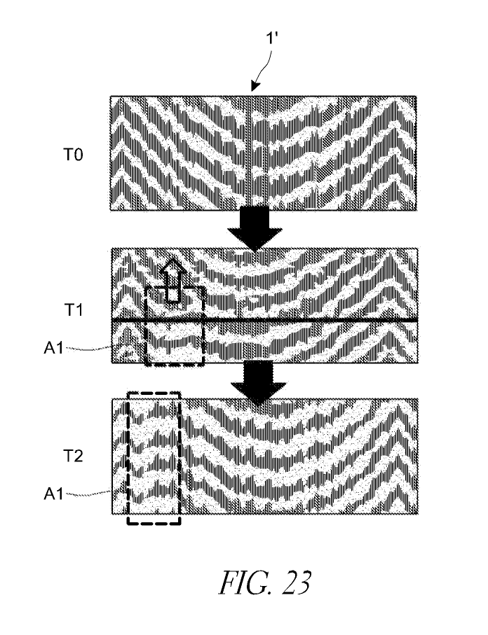

As described above, if the optical modulation device 1 is substantially periodically turned off, the deterioration of performance of the lens or the prism that is realized by the modulation device 1 can be prevented. This will be described with reference to FIG. 23 to FIG. 25 along with the above-described drawings.

Firstly, referring to FIG. 23, an optical modulation device 1′ is the same as the optical modulation device 1 so far described, but the optical modulation device 1′ is only driven by the step (Step1) of FIG. 9 and is not reset at the reset section Rs. Thus, as shown in FIG. 23, like a first time T0, the driving signal of the first step (Step1) is applied and the normal arrangement of the liquid crystal molecules 31 is formed after the arrangement of the liquid crystal molecules 31 are stable such that the optical modulation device 1′ is normally operated. However, at a second time T1 after the first time T0, the abnormal region A1 where the arrangement of the liquid crystal molecules 31 is partially scattered can be generated by a foreign particle, a twist of a spacer, or damage to the aligners 11 and 21. The abnormal region A1 affects the arrangement of the surrounding liquid crystal molecules 31 such that the abnormal region A1 is gradually expanded. At a third time T2 after the second time T1, the abnormal region A1 can be confirmed at the wide region of the optical modulation device 1. Accordingly, an error can be generated in the phase realized by the optical modulation device 1, and the diffraction efficiency can be decreased.

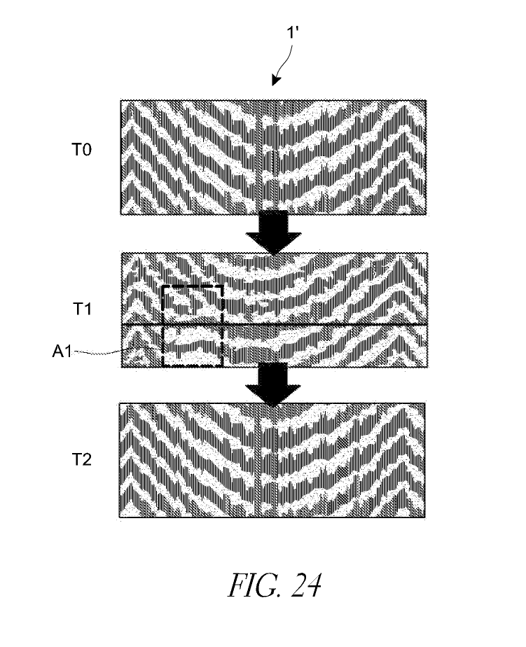

However, referring to FIG. 24, if the optical modulation device 1 is substantially periodically reset according to the driving method of the optical modulation device 1 according to at least one of the disclosed embodiments, the above problems are not generated. Like the time T0, the driving signal of the first step (Step1) is applied and the normal arrangement of the liquid crystal molecules 31 is formed after the arrangement of the liquid crystal molecules 31 is stable such that the optical modulation device 1′ is normally operated. However, at the second time T1 after the first time T0, the abnormal region A1 where the arrangement of the liquid crystal molecules 31 is partially scattered by the foreign particle, the twist of the spacer, or the damage to the aligners 11 and 21 can be generated. As the abnormal region A1 is gradually expanded, the error can be partially generated at the phase change realized by the optical modulation device 1, and the interference can be generated in the image displayed by the display device using the optical modulation device 1. However, according to at least one of the disclosed embodiments, when an interference index reaches a predetermined value, the optical modulation device 1 is substantially periodically reset at the reset section Rs and the driving signals of the steps (Step1, Step2, and Step3) are applied such that the abnormal region A1 disappears.

Referring to FIG. 24, the reset section Rs is positioned at the second time T1 and the abnormal region A1 has disappeared at the third T2 after the reset. Accordingly, the optical modulation device 1 is operated to not exceed the predetermined interference index such that the normal phase modulation of the predetermined degree can always be realized and the targeted diffraction efficiency can be maintained.

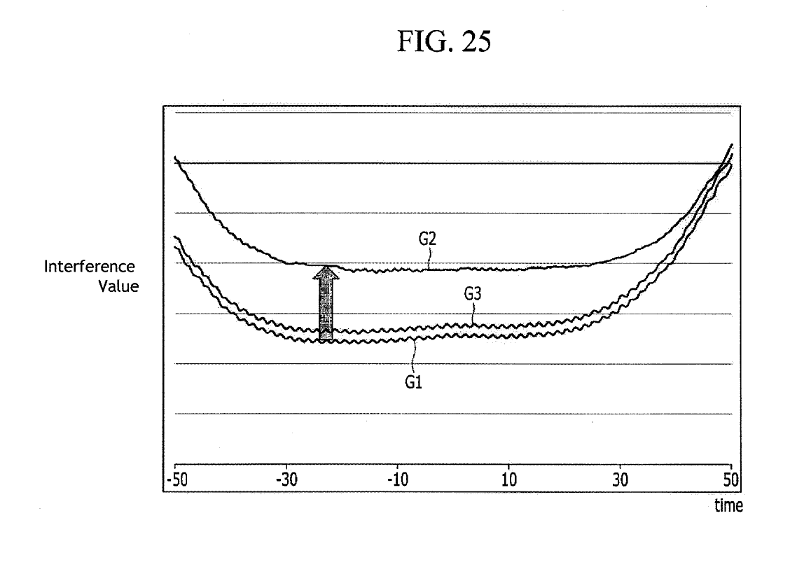

FIG. 25 is a graph showing an interference value of the optical modulation device shown in FIG. 23 and FIG. 24.

Referring to FIG. 25, the driving signals of the steps (Step1, Step2, and Step3) are applied and the arrangement of the liquid crystal molecules 31 is stable, and then the arrangement has the low interference value, as shown by the curve G1. Referring to FIG. 23, as described above, when the optical modulation device is not substantially periodically reset, like the curve G2 of FIG. 25, the interference value is significantly increased such that the diffraction efficiency is decreased and the interference is generated in the stereoscopic image displayed by using the optical modulation device.

However, like in some embodiments, if the optical modulation device 1 is substantially periodically reset, like the curve G3 of FIG. 25, the interference value of the optical modulation device 1 is somehow deteriorated and then is reset, and if the driving signals of the steps (Step1, Step2, and Step3) are applied, the interference value is not further deteriorated rather than the graph G3 and the interference value can be again decreased to the degree of the curve G1. Accordingly, if the reset section Rs is periodically repeated, the optical modulation device 1 can be controlled to only have the interference value between two curves G1 and G3 of FIG. 25 such that the normal phase change of the predetermined degree can be realized.

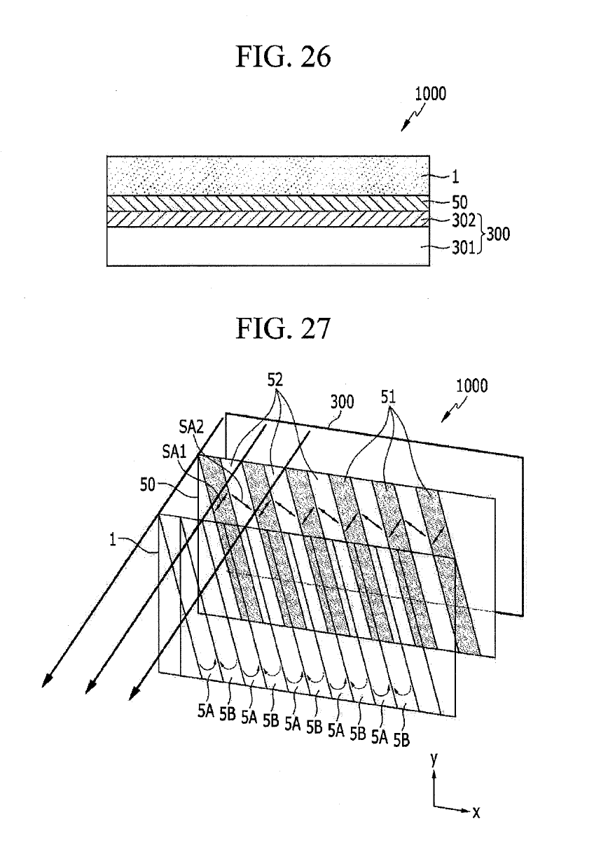

Next, the electronic device including the optical modulation device and the driving thereof according to an exemplary embodiment will be described with reference to FIG. 26 to FIG. 31 along with the above-described drawings.

Referring to FIG. 26 and FIG. 27, the electronic device 1000 as the stereoscopic image display device includes a display panel 300, a phase retardation plate 50, and the optical modulation device 1.

The display panel 300 can display a 2D image in a 2D mode, and can divide the image corresponding to different viewing points by spatial division or temporal division to alternately display by position or time in a 3D mode. For example, in the 3D mode, some pixels among a plurality of pixels display an image corresponding to any one viewing point, and the other pixels display the image corresponding to a different viewing point. A number of viewing points can be two or more.

The display panel 300 can include a plurality of electronic elements to display the images, for example, an active substrate 301 including a plurality of signal lines and a plurality of pixels PX connected thereto, and a polarizer 302 adhered to the active substrate 301. The polarizer 302 linearly polarizes incident light in a direction substantially parallel to a transmissive axis. The linearly polarization direction of the polarizer 302 can be an x-axis direction or a y-axis direction, however it is not limited thereto. As shown in FIG. 26, the polarizer 302 is positioned between the active substrate 301 and the phase retardation plate 50, but the position of the polarizer 302 is not limited thereto.

The display panel 300 can be various display panels such as an organic light-emitting diode (OLED) panel including an organic light-emitting diode or a liquid crystal panel including a liquid crystal layer. When the display panel 300 is the liquid crystal panel, the display panel 300 can include a pair of polarizers (not shown) that are positioned at respectively surfaces of the active substrate 301. The transmissive axes of the two polarizers can be crossed.

The phase retardation plate 50 can be positioned before a surface in which the image of the display panel 300 is displayed, and can be a film type. The phase retardation plate 50 can be a quarter-wave plate providing phase retardation of a ¼ wavelength to the transmitted light. The light of the image emitted from the display panel 300 is linearly polarized such that it is circularly polarized through the phase retardation plate 50.

For example, the phase retardation plate 50 as a patterned phase retardation plate (a patterned retarder) includes a first part 51 and a second part 52 having the different optical axis or slow axis. The first part 51 and the second part 52 can be alternately arranged in the x-axis direction. Also, a center axis of the first part 51 and the center axis of the second part 52, or the boundaries of the first part 51 and the second part 52, can be obliquely inclined with reference to the y-axis direction.

The slow axis SA1 of the first part 51 can be inclined by about 45 degrees with reference to the x-axis direction, and the slow axis SA2 of the second part 52 can be inclined by about 135 degrees or −45 degrees with reference to the x-axis direction, and vice versa. The case where the slow axis SA1 of the first part 51 is inclined by about 45 degrees with reference to the x-axis direction and the slow axis SA2 of the second part 52 is inclined by about 135 degrees or −45 degrees with reference to the x-axis direction will be mainly described, but embodiments are not limited thereto.

In this case, if the light passing through the polarizer 302 is linearly polarized and emitted in the x-axis direction and then passes through the first part 51 of the phase retardation plate 50, the left-circular polarized light can be emitted and the right-circular polarized light can be emitted when the linearly polarized light passes through the second part 52 of the phase retardation plate 50. Alternatively, if the light passing through the polarizer 302 is linearly polarized and emitted in the y-axis direction and then passes through the first part 51 of the phase retardation plate 50, the right-circular polarized light can be emitted and the left-circular polarized light can be emitted when the linearly polarized light passes through the second part 52 of the phase retardation plate 50.

The optical modulation device 1 is positioned before the phase retardation plate 50. The optical modulation device 1 is the same as described above such that the same description is omitted.

In some embodiments, the optical modulation device 1 includes a first region 5A and a second region 5B respectively corresponding to the first part 51 and the second part 52 of the phase retardation plate 50. The widths of the first part 51 and the first region 5A corresponding to each other can be substantially the same or can have a predetermined difference. Likewise, the widths of the second part 52 and the second region 5B corresponding to each other can be substantially the same or can have a predetermined difference.

The direction of the phase change of the x-axis direction generated in the first region 5A is substantially the same as the direction of the phase change of the x-axis direction generated in the second region 5B. That is, when the optical modulation device 1 is turned on, in the case that the forward phase inclination in which the phase retardation value is increased along the x-axis direction in the first region 5A appears, the forward phase inclination in which the phase retardation value is increased along the x-axis direction can also appear in the second region 5B. In contrast, when the optical modulation device 1 is turned on, in the case that the reverse phase inclination in which the phase retardation value is decreased along the x-axis direction in the first region 5A appears, the forward phase inclination in which the phase retardation value is decreased along the x-axis direction can also appear in the second region 5B.

A region where the phase retardation value is changed along the x-axis direction from about 0 to about 2π (radian) or from about 2π (radian) to about 0 is referred to as a unit region (Unit), and the first region 5A and the second region 5B respectively include at least one unit region (Unit). Also, when the first region 5A and the second region 5B respectively include a plurality of unit regions (Units), the width of the unit regions (Unit) included in the first region 5A or the second region 5B can be different.

Since the circularly polarized light is differently incident in the first region 5A and the second region 5B, the progressing direction passing through the first region 5A and the progressing direction passing through the second region 5B are different from each other. By differently controlling the progressing angles of the light passing through the first region 5A and the second region 5B, the first region 5A and the second region 5B can function as one lens collecting the light. Accordingly, a pitch of the first part 51 and the second part 52 of the phase retardation plate 50 can be about half of the pitch of a plurality of lens formed in the optical modulation device 1. That is, the width of the first part 51 or the second part 52 in the x-axis direction can be about half of one lens formed by the optical modulation device 1 in the x-axis direction.

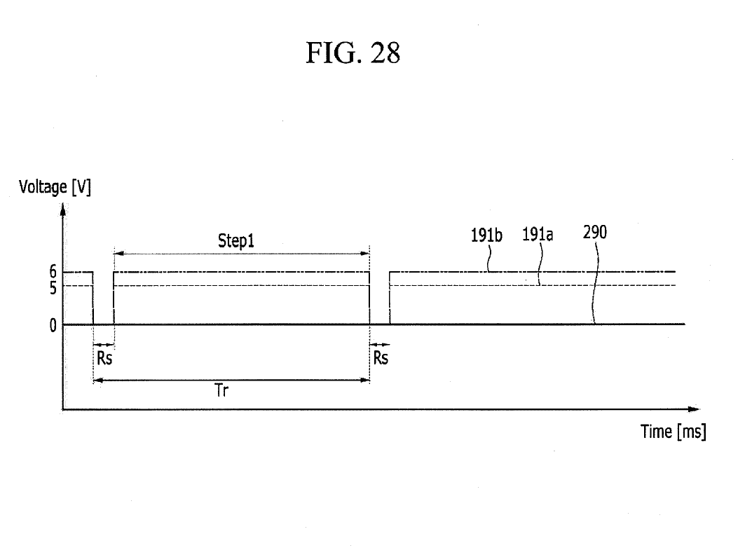

Next, the driving method of the optical modulation device 1 included in the electronic device 1000 will be described with reference to FIG. 28.

Referring to FIG. 28, the driving method according to the present exemplary embodiment is almost the same as the driving method shown in FIG. 9, but the step driving section does not include the second step (Step2) or the third step (Step3), and only includes the first step (Step1). That is, the period Tr in which the optical modulation device 1 is repeatedly applied with the driving signal includes the first step (Step1) and the reset section Rs, and the first step (Step1) and the reset section Rs can be alternately repeated. The driving signal of the first step (Step1) is the same as described above.

If the optical modulation device 1 is applied with the driving signal of the first step (Step1), the liquid crystal molecules 31 can form the substantially “u” shape arrangement. If the light that is circularly-polarized in the predetermined direction is passed through the optical modulation device 1, the forward phase slope portion or the backward phase slope portion of the lens in that the direction of the light is changed can be realized.

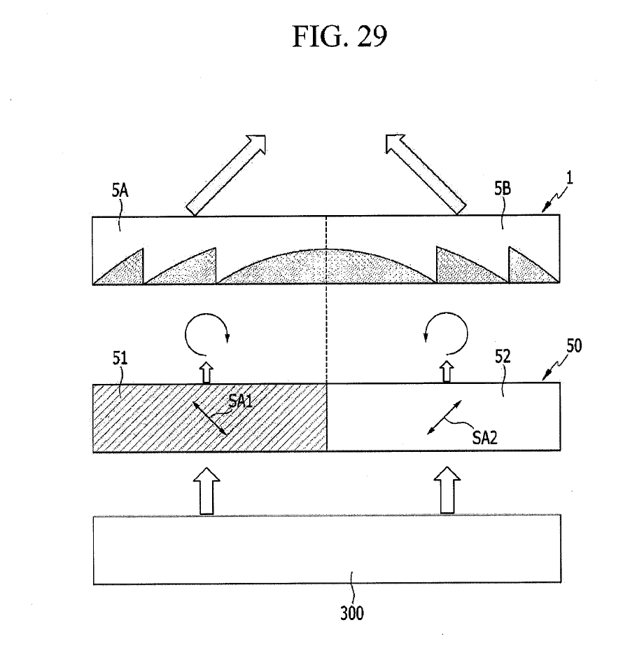

Also, the direction of the phase inclination of the light can be different depending on the circular polarization direction of the light incident to the turned-on optical modulation device 1, thereby realizing the various optical devise such as the lens. This will be described with reference to FIG. 29 to FIG. 31.

Referring to FIG. 29, the image displayed in the display panel 300 is linearly polarized through the polarizer 302 and then is incident to the phase retardation plate 50. An example in which the light that is linearly polarized in the y-axis direction is incident to the phase retardation plate 50 will be described. That is, linearly polarized light incident to the first part 51 of the phase retardation plate 50 is right-circularly polarized and emitted along the slow axis SA1 that is inclined by about 45 degrees with reference to the x-axis direction, and the linearly polarized light incident to the second part 52 is left-circularly polarized and emitted along the slow axis SA2 that is inclined by about 135 degrees with reference to the x-axis direction. Next, the right-circularly polarized light is incident to the first region 5A of the turned-on optical modulation device 1, and the left-circularly polarized light is incident to the second region 5B of the turned-on optical modulation device 1.

The right-circularly polarized light incident to the first region 5A experiences the forward phase inclination that is changed from about 0 to about 2π (radian) along the x-axis direction such that the first region 5A can function like the left portion La with reference to a center O of the Fresnel lens, and the left-circularly polarized light incident to the second region 5B experiences the reverse phase inclination that is changed from about 2π (radian) to about 0 along the x-axis direction such that the second region 5B can function like the right portion Lb with reference to the center O of the Fresnel lens.

A plurality of forward phase inclinations of the left portion La and the right portion Lb of the Fresnel lens realized by the optical modulation device 1 can have different widths depending on position, and for this, the width of the lower electrode 191 of the optical modulation device 1 corresponding to each forward phase inclination portion and/or the number of lower electrodes 191 included in one unit region (Unit) can be appropriately controlled. If the voltage applied to the lower electrode 191 and the upper electrode 290 is controlled, the phase curvature of the Fresnel lens can be changed.

This optical modulation device can function as the lens to be used in the optical device such as the stereoscopic image display device.

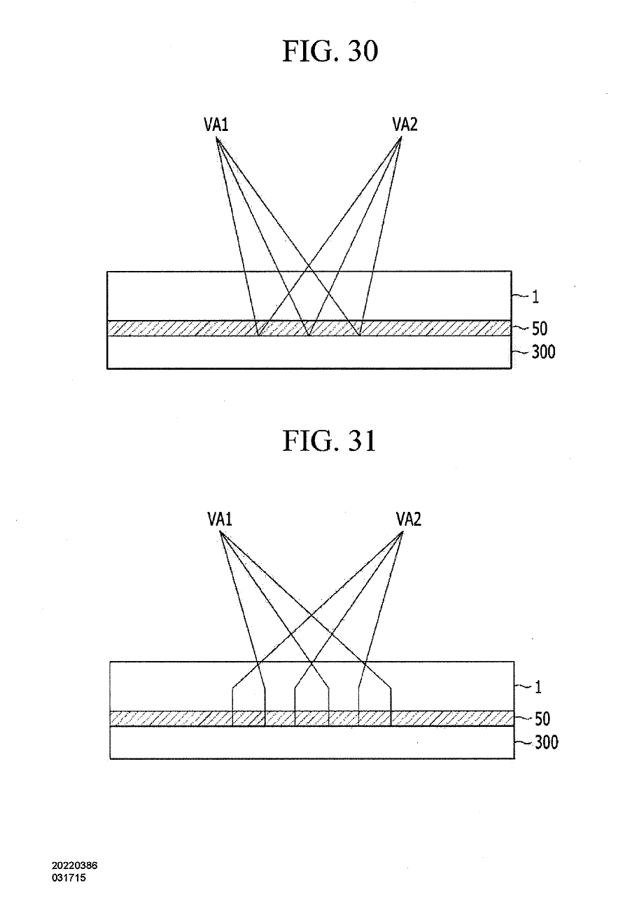

Referring to FIG. 30 and FIG. 31, the displayed stereoscopic image display device is the same as the electronic device 1000 according to the above-described exemplary embodiment.

The display panel 300 displays the 2D image of each frame in the 2D mode as shown in FIG. 20, and displays the 3D image by spatially dividing various viewpoint images such as a left eye image and a right eye image by a spatial division method in a 3D mode as shown in FIG. 31. In the 3D mode, some of the pixels can display an image corresponding to one of viewpoints VA1 and VA2, and other pixels thereof can display an image corresponding to the other of the viewpoints VA1 and VA2. The number of viewpoints VA1 and VA2 can be two or more.

The optical modulation device 1 repeatedly realizes the Fresnel lens including a plurality of forward phase inclination portions and a plurality of reverse phase inclination portions along with the phase retardation plate 50 to divide the image displayed in the display panel 300 for each viewing point.

The optical modulation device 1 can function as an on/off switching device. If the optical modulation device 1 is turned on, the stereoscopic image display device is operated with the 3D mode, and as shown in FIG. 31, the image displayed in the display panel 300 is refracted to form a plurality of Fresnel lens to display the image at the corresponding viewing points. In contrast, if the optical modulation device 1 is turned off, as shown in FIG. 30, the image displayed in the display panel 300 is not refracted and is passed, thereby observing the 2D image.

While the inventive technology has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for driving an optical modulation device, the method comprising:
first applying a plurality of driving voltages having different voltage values to a plurality of lower electrodes and a selected one of the driving voltages to an upper electrode so as to generate substantially periodic phase modulation to a liquid crystal layer, wherein the optical modulation device includes a first plate including the lower electrodes and a first aligner, a second plate facing the first plate and including an upper electrode and a second aligner, and the liquid crystal layer positioned between the first and second plates, and wherein the alignment directions of the first and second aligners are substantially parallel to each other; and
second applying a reset signal to the lower electrodes and the upper electrode so as to turn off the optical modulation device,
wherein the first applying and the second applying are alternately performed.

2. The method of claim 1, wherein, in the second applying, the voltage difference between the lower electrodes and the upper electrode is substantially 0V.

3. The method of claim 2, wherein the second applying is performed when an interference degree, in which an arrangement of liquid crystal molecules included in the liquid crystal layer is partially scattered, is about 5% to about 10% after the first applying.

4. The method of claim 3, wherein the second applying is performed every about 8 seconds to about 30 seconds.

5. The method of claim 4, wherein the second applying is performed for about one second or less.

6. The method of claim 5, wherein during the first applying, in the liquid crystal layer corresponding to a first unit region including a first lower electrode of the lower electrodes, an electric field intensity in a region adjacent to the first plate is greater than an electric field intensity in a region adjacent to the second plate.

7. The method of claim 6, wherein during the first applying, in the liquid crystal layer corresponding to a second unit region including a second lower electrode of the lower electrodes and adjacent to the first unit region, the electric field intensity in a region adjacent to the first plate is less than the electric field intensity in a region adjacent to the second plate.

8. The method of claim 7, wherein during the first applying, a voltage applied to the first lower electrode is greater than a voltage applied to the second lower electrode.

9. The method of claim 8, wherein during the first applying, a first voltage is applied to the first lower electrode, a second voltage different from the first voltage is applied to the second lower electrode, and a third voltage different from the first and second voltages is applied to the upper electrode so as to form a first phase slope.

10. The method of claim 9, the first applying comprises:
after the first to third voltages are respectively applied to the first and second lower electrodes and the upper electrode, applying a fourth voltage having an opposite polarity to the first voltage to the first lower electrode; and
applying a fifth voltage greater than the first voltage to the first lower electrode after the applying of the fourth voltage.

11. The method of claim 1, wherein the second applying is performed when an interference degree, in which an arrangement of liquid crystal molecules included in the liquid crystal layer is partially scattered, is about 5% to about 10% after the applying of the driving voltage.

12. The method of claim 1, wherein the second applying is performed every about 8 seconds to about 30 seconds.

13. The method of claim 1, wherein the applying of the reset signal is performed for about one second or less.

14. An optical modulation device for a display device, comprising:
a first plate including a plurality of lower electrodes and a first aligner;
a second plate facing the first plate and including an upper electrode and a second aligner;
a voltage application device configured to apply voltages to the lower and upper electrodes; and
a liquid crystal layer positioned between the first and second plates,
wherein the alignment directions of the first and second aligners are substantially parallel to each other, and
wherein the voltage application device is configured to alternately apply i) a driving voltage to the lower and upper electrodes and ii) a reset signal to the lower and upper electrodes so as to turn off the optical modulation device.

15. The optical modulation device of claim 14, wherein the voltage difference between a voltage of the lower electrodes and a voltage of the upper electrode is substantially 0V when the voltage application device is applying the reset signal.

16. The optical modulation device of claim 15, wherein the voltage application device is further configured to apply the reset signal to the lower electrodes and the upper electrode when an interference degree, in which an arrangement of liquid crystal molecules included in the liquid crystal layer is partially scattered, is about 5% to about 10% after the driving voltage is applied to the lower and upper electrodes.

17. The optical modulation device of claim 16, wherein the voltage application device is further configured to apply the reset signal every period that ranges from about 8 seconds to about 30 seconds.

18. The optical modulation device of claim 17, wherein the voltage application device is further configured to apply the reset signal for about one second or less.

19. An optical modulation device for a display device, comprising:
a first plate including a plurality of lower electrodes;
a second plate facing the first plate and including an upper electrode;
a liquid crystal layer positioned between the first and second plates and including a plurality of liquid crystal molecules each having an alignment direction corresponding to a default direction; and
a voltage application device configured to i) apply driving voltages, for a duration of first and second periods, to the lower and upper electrodes so as to change the alignment direction of the liquid crystal molecules and ii) reset the alignment direction to the default direction between the first and second periods.

20. The device of claim 19, wherein the lower electrodes include a first lower electrode and a second lower electrode adjacent to the first lower electrode, and wherein the voltage application device is further configured apply different driving voltages to the first and second lower electrodes and the upper electrode.
